(19) United States
(12) Patent Application Publication
(10) Pub. No.: US 2026/0089268 A1
(43) Pub. Date: Mar. 26, 2026

(54) IMAGE PROCESSING APPARATUS AND METHOD OF CONTROLLING SAME

(71) Applicant: CANON KABUSHIKI KAISHA, Tokyo (JP)

(72) Inventor: KYOHEI KIKUTA, Tokyo (JP)

(21) Appl. No.: 19/325,728

(22) Filed: Sep. 11, 2025

(30) Foreign Application Priority Data
Sep. 25, 2024 (JP) 2024-166562

(51) Int. Cl. H04N 1/00

(52) U.S. Cl. CPC H04N 1/00005; H04N 1/00015; H04N 1/00037; H04N 1/00076; H04N 1/00087

(57) ABSTRACT

The image processing apparatus comprising: one or more memory devices that store a set of instructions; and one or more processors that execute the set of instructions to: obtain an image of one side of a sheet, process a sheet image obtained and detect a feature of the sheet image, determine whether or not there is an abnormality in the sheet image obtained based on a feature detected, set content to be displayed on a screen in a case where it is determined that there is an abnormality in the sheet image, and output the content set.

### BACKGROUND

### Field of the Technology

The present disclosure relates to an image processing apparatus and a method of controlling the same.

### Description of the Related Art

In the printing industry, typically, an inspection (examination) is performed after printing completion to ensure that there are no abnormalities in printed product to be delivered to a client and there are no problems in terms of quality. A known technology performs an inspection task automatically as a post-processing of a printer. In an example of such inspection technology, first, reference image data representing a printed product with no abnormalities is obtained and registered. Next, submitted image data is printed on a print medium (sheet for printing) by an image forming apparatus, and this is scanned by a sensor (scanning apparatus) as image data. An inspection is performed of whether or not there is an abnormality in the printed material by comparing the scan data obtained by the sensor and the registered reference image data. The result of the inspection is displayed to the user via a screen, or inspection results are collected, stored, and output as an inspection report.

However, the user references the result of the inspection and actually confirms the abnormality in the printed product. Plausible reasons for confirming the abnormality include, even if the sample is determined to have a minor abnormality, it may actually be a quality level acceptable for humans or the abnormal determination may have been due to deposits (dust and the like) being temporarily present at the time of scanning. By confirming samples in this manner and treating them as passed products, wasting time and the like in regards to sheets for printing, color material, and re-printing can be reduced. Also, in a case where a major abnormality is confirmed, calibration can be performed for the image forming apparatus or a maintenance service can be requested. Also, if an abnormality is confirmed, this can be taken into account and applied to the subsequent inspection settings so that a more appropriate inspection can be performed. Accordingly, it is important that, via the display of an inspection result and an inspection report, the result of an inspection (position of abnormality, for example) can be smoothly confirmed. Japanese Patent Laid-Open No. 2021-037736 describes an example of displaying an abnormality position in such a case.

Regarding an abnormality position display of the inspection result, the information may be presented to the user by displaying the scanned printed material and highlighting the abnormality position, displaying the coordinates on the sheet surface, and the like. However, with such as display method, a standard abnormality position display is performed not taking into account the printed content of the printed material. Thus, depending on the content of the printed material, the user cannot easily recognize the abnormality position, leading to the possibility of a decreasing in the ease of use for the user.

### SUMMARY

The present disclosure enables realization of a novel mechanism for enabling easy recognition of a position of a printing abnormality in accordance with the contents of a printed material.

One aspect of the present disclosure provides an image processing apparatus comprising: one or more memory devices that store a set of instructions; and one or more processors that execute the set of instructions to: obtain an image of one side of a sheet, process a sheet image obtained and detect a feature of the sheet image, determine whether or not there is an abnormality in the sheet image obtained based on a feature detected, set content to be displayed on a screen in a case where it is determined that there is an abnormality in the sheet image, and output the content set, wherein the one or more processors execute instructions in the one or more memory devices to: set a reference point in the sheet image and set whether or not to display relative position information indicating a relative position of the abnormality with respect to the reference point, and set the relative position information to be displayed on the screen in a case where display of the relative position information is set to yes.

Another aspect of the present disclosure provides a control method for an image processing apparatus comprising: obtaining an image of one side of a sheet; processing a sheet image obtained and detecting a feature of the sheet image; determining whether or not there is an abnormality in the sheet image obtained based on a feature detected; setting content to be displayed on a screen in a case where it is determined that there is an abnormality in the sheet image; and outputting the content set, wherein a reference point is set in the sheet image and whether or not to display relative position information indicating a relative position of the abnormality with respect to the reference point is set, and the relative position information to be displayed on the screen is set in a case where display of the relative position information is set to yes.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram of a printed image inspection system according to an embodiment.

FIG. 2 is a diagram illustrating the hardware configuration of an image processing apparatus according to an embodiment.

FIG. 3 is a diagram illustrating the hardware configuration of each apparatus according to an embodiment.

FIG. 4 is a diagram illustrating functional blocks of each apparatus according to an embodiment.

FIGS. 5A and 5B are flowcharts illustrating a processing procedure according to an embodiment.

FIG. 6 is a diagram illustrating a display screen according to an embodiment.

FIG. 7 is a flowchart illustrating a processing procedure according to an embodiment.

FIG. 8 is a diagram for describing a Hough transform according to an embodiment.

FIG. 9 is a diagram illustrating a display screen according to an embodiment.

FIG. 10 is a diagram illustrating a display screen according to an embodiment.

FIG. 11 is a diagram illustrating a display screen according to an embodiment.

FIG. 12 is a diagram illustrating a display screen according to an embodiment.

FIG. 13 is a diagram illustrating a display screen according to an embodiment.

FIG. 14 is a diagram illustrating a display screen according to an embodiment.

FIG. 15 is a diagram illustrating a display screen according to an embodiment.

FIG. 16 is a diagram illustrating a display screen according to an embodiment.

FIG. 17 is a diagram illustrating a display screen according to an embodiment.

FIG. 18 is a diagram illustrating a display screen according to an embodiment.

FIG. 19 is a diagram illustrating functional blocks of each apparatus according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present specification, the term “image forming apparatus” broadly includes in its meaning apparatuses that form (print) an image on a printing material (printing medium) such as a single-function printer, a copy machine, a multi-function peripheral, a commercial printer, and the like.

### System Configuration

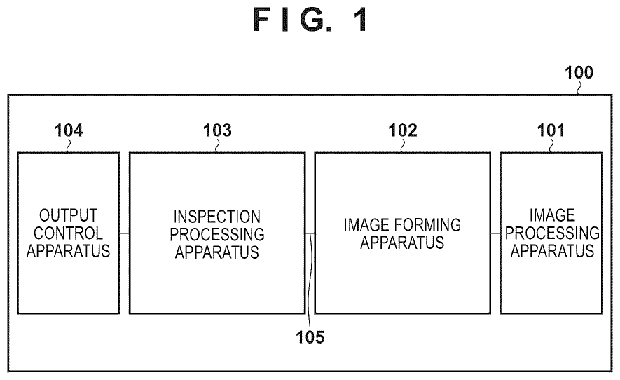

The overall configuration of a printed image inspection system 100 according to the present embodiment will now be described using FIG. 1. The printed image inspection system 100 includes an image processing apparatus 101, an image forming apparatus 102, an inspection processing apparatus 103, an output control apparatus 104, and a communication cable 105 connecting these apparatuses.

The image processing apparatus 101 has the role of a printer server. In other words, the image processing apparatus 101 executes processing to perform raster image processor (RIP) processing on input print data and document data for conversion into a bitmap and generate image data (hereinafter, also referred to as printing data) for image formation (printing). The image processing apparatus 101 also functions as a server that performs control relating to printing performed by the image forming apparatus 102 and manages the print jobs. Note that hereinafter, the image processing apparatus 101 may also be referred to as a digital front end (DFE).

The image forming apparatus 102 is an apparatus, that is, a printer, that forms or prints an image on a print medium (sheet for printing) on the basis of the printing data generated by the image processing apparatus 101. Examples of image forming methods may include an offset printing method, an electro-photographic method, an inkjet method, or the like, but the present disclosure can be applied to any method that can form an image on a print medium. Note that in the present embodiment, the image forming apparatus 102 is an electro-photographic image forming apparatus.

The inspection processing apparatus 103 determines, for each piece of printed material, whether there is an abnormality in the printed material printed by the image forming apparatus 102, that is, whether there is a problem in the quality. The output control apparatus 104 switches the discharge destination, performs post-processing as necessary (book binding and the like), and the like on the basis of the determination result of the inspection processing apparatus 103. Note that the output control apparatus 104 may also be referred to as a finisher. By the cooperation of these apparatuses, a function for obtaining a printed product confirmed via inspection to have no abnormality is achieved.

### Hardware Configuration of Image Processing Apparatus 101

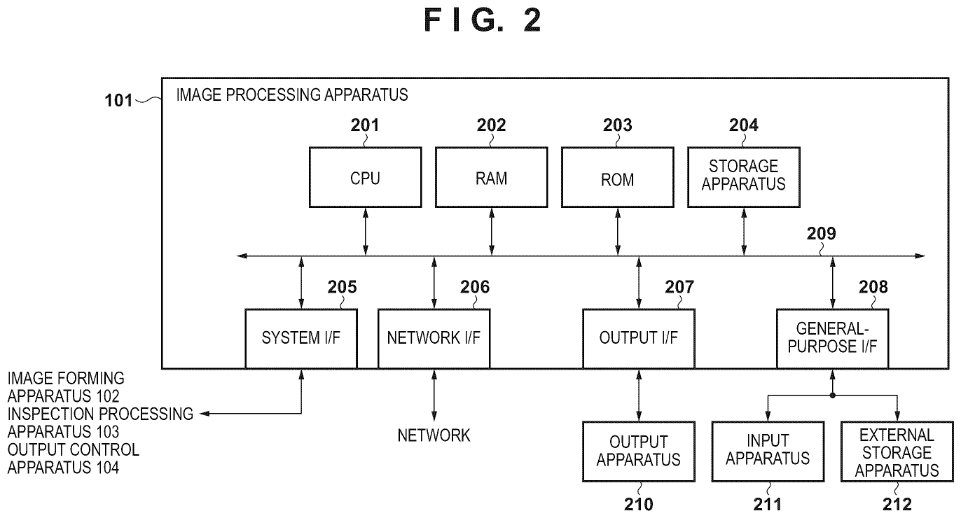

The hardware configuration of the image processing apparatus 101 will now be described using FIG. 2. The image processing apparatus 101 includes a CPU 201, a RAM 202, a ROM 203, a storage apparatus 204, a system interface (I/F) 205, a network I/F 206, an output I/F 207, a general-purpose I/F 208, and a main bus 209. Also, an output apparatus 210 is connected to the image processing apparatus 101 via the output I/F 207, and an input apparatus 211 and an external storage apparatus 212 are connected to the image processing apparatus 101 via the general-purpose I/F 208.

The central processing unit (CPU) 201 is a processor that comprehensively controls each unit included in the image processing apparatus 101. In the example described here, the CPU 201 controls the entire image processing apparatus 101. However, the entire image processing apparatus 101 may be controlled by the processing being shared between a plurality of pieces of hardware. Also, a portion of the control processing of the CPU 201 may be executed by hardware such as an Application Specific Integrated Circuit (ASIC), a Field-Programmable Gate Array (FPGA), or the like. The random-access memory (RAM) 202 functions as a main memory of the CPU 201 and a working area. The read-only memory (ROM) 203 stores a program group executed by the CPU 201. The storage apparatus 204 in this example indicates a large-capacity auxiliary storage apparatus that, for example, stores applications executed by the CPU 201, data used in image processing, and the like.

The system I/F 205 includes a connection module such as a connector and is connected to each apparatus in the printed image inspection system 100, that is, the image forming apparatus 102, the inspection processing apparatus 103, and the output control apparatus 104. Also, the image processing apparatus 101, via the system I/F 205, exchanges operating status, synchronizes timing, and exchanges data with each apparatus. The network I/F 206 includes a communication module (for example, a network interface card) and connects to a network external to the printed image inspection system 100 and exchanges data. The output I/F 207 includes a connection module such as a connector and is an image output interface such as High-Definition Multimedia Interface (HDMI, registered trademark). The output apparatus 210, such as a liquid crystal display, and the image processing apparatus 101 are connected via the output I/F 207. Note that the output apparatus 210 functions as a user interface that presents the state of the image processing apparatus 101 to the user.

The general-purpose I/F 208 is a bus interface including a connector of USB, IEEE 1394, or similar standard. The image processing apparatus 101 is connected to the input apparatus 211, such as a keyboard, a mouse, or the like, via the general-purpose I/F 208 and receives information of user operations (instructions). Also, the image processing apparatus 101 is connected to the external storage apparatus 212 via the general-purpose I/F 208 and can stored data such as log data in the external storage apparatus 212 and obtain data from the external storage apparatus 212. The main bus 209 communicatively connects each piece of hardware of the image processing apparatus 101.

Note that the hardware configuration of the image processing apparatus 101 is not limited to the configuration described above. For example, the external apparatuses described above such as the output apparatus 210 may exist inside the image processing apparatus 101 via the main bus 209. Also, the output apparatus 210 and the input apparatus 211 may be integrally formed as a touch panel display or the like. The image processing apparatus 101 may include a graphics processing unit (GPU), which is a processor specialized in high-speed parallel calculations, and a portion of the control processing of the CPU 201 may be executed by the GPU.

### Hardware Configuration of Other Apparatuses

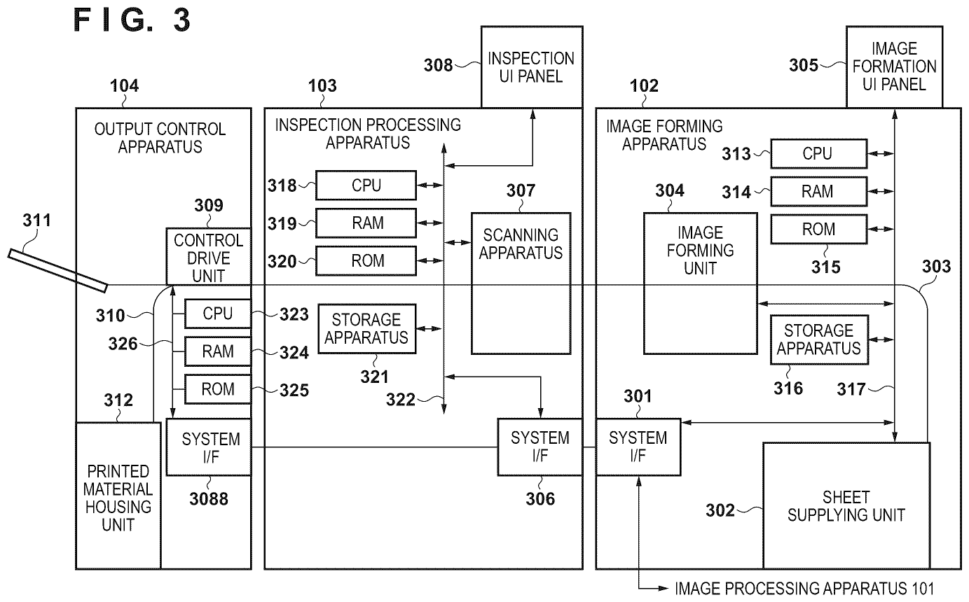

The hardware configuration of the image forming apparatus 102, the inspection processing apparatus 103, and the output control apparatus 104 will now be described using FIG. 3. However, hardware configurations provided in the apparatuses that are similar to that of the image processing apparatus 101 illustrated in FIG. 2 will not be described.

The image forming apparatus 102 is connected to other apparatuses in the printed image inspection system 100 via a system I/F 301. The image forming apparatus 102 includes a sheet supplying unit 302, a sheet conveying unit 303, an image forming unit 304, and a touch panel display (in the present specification, this may also be referred to as an image forming UI panel) 305 corresponding to a user interface (UI). The sheet supplying unit 302 supplies the sheet for printing inside the image forming apparatus 102 via the sheet conveying unit 303. The sheet conveying unit 303 conveys the sheet for printing supplied from the sheet supplying unit 302 using a rotary roller (not illustrated) and the like. The sheet conveying unit 303 is provided spanning throughout the image forming apparatus 102, the inspection processing apparatus 103, and the output control apparatus 104 and can convey a sheet for printing to each apparatus.

The image forming unit 304 forms an image on the sheet for printing conveyed along the sheet conveying unit 303 on the basis of printing data transmitted from the image processing apparatus 101. For example, in the case of an electro-photographic image forming apparatus, the color material (toner) held in an image shape on the photosensitive drum by voltage control is transferred and fixed to a sheet for printing. An image formation UI panel 305 is a touch panel display corresponding to the UI of the image forming apparatus 102, with it corresponding to the output apparatus 210 and the input apparatus 211 of the image processing apparatus 101. Also, as in the image processing apparatus 101 described above, the image forming apparatus 102 includes a CPU 313, a RAM 314, a ROM 315, a storage apparatus 316, and a main bus 317.

The inspection processing apparatus 103 is connected to other apparatuses inside the printed image inspection system 100 via a system I/F 306. The inspection processing apparatus 103 includes a scanning apparatus 307 and a touch panel display (also referred to as an inspection UI panel) 308 corresponds to a UI. The scanning apparatus 307 is an apparatus (scanner) that can obtain image data (hereinafter referred to as scan data) of a printed material conveyed via the sheet conveying unit 303 via an inbuilt light source and a sensor (light-receiving unit) such as a charge-coupled device (CCD). In the present embodiment, the printed material can be obtained in an image format with each pixel having red, green, and blue (RGB) 3 channels and 8-bit per channel. The inspection UI panel 308 is a touch panel display corresponding to the UI of the inspection processing apparatus 103, with it corresponding to the image formation UI panel 305 of the image forming apparatus 102. Also, as in the image processing apparatus 101 described above, the inspection processing apparatus 103 includes a CPU 318, a RAM 319, a ROM 320, a storage apparatus 321, and a main bus 322.

The output control apparatus 104 is connected to other apparatuses inside the printed image inspection system 100 via a system I/F 3088. The output control apparatus 104 includes a control drive unit 309, a conveying branch unit 310, which is a branch of the sheet conveying unit 303, a printed material discharge unit 311, and a printed material housing unit 312. The control drive unit 309 switches the conveying path of the printed material conveyed by the sheet conveying unit 303 to the conveying branch unit 310 depending on the inspection result of the inspection processing apparatus 103. Note that the printed material housing unit 312 is provided at the distal end of the conveying branch unit 310. Also, output printed material that fail inspection are discharged to the printed material discharge unit 311. Output printed material that pass inspection are housed in the printed material housing unit 312. Via this operation of the control drive unit 309, the passed products and the failed products are sorted and housed. Thus, ultimately, the printed products confirmed to have no abnormalities are stacked in one tray. Also, as in the image processing apparatus 101 described above, the output control apparatus 104 includes a CPU 323, a RAM 324, a ROM 325, and a main bus 326.

### Functional Configuration of Printed Image Inspection System

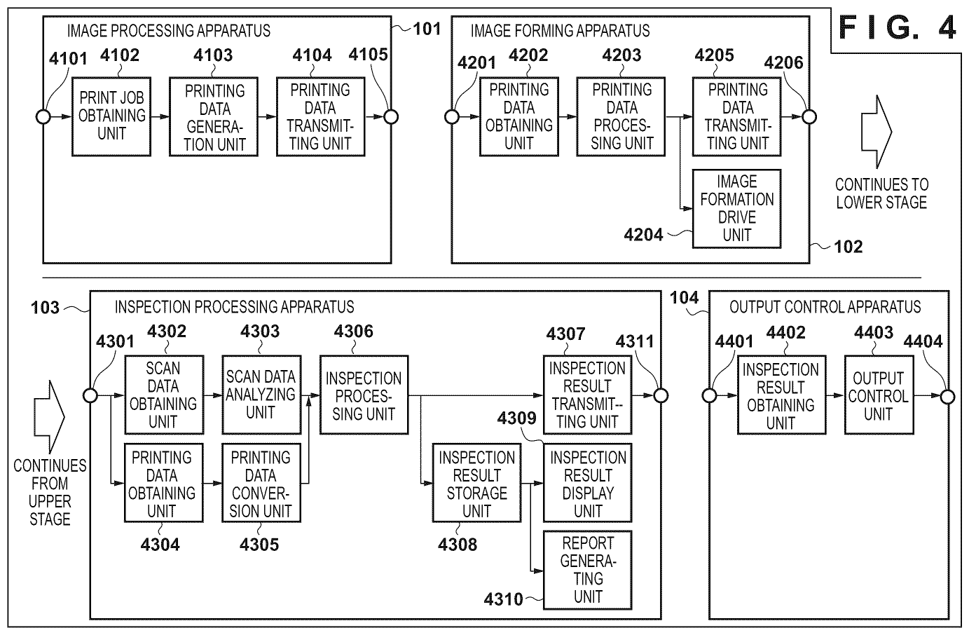

The functional blocks of the printed image inspection system 100 will now be described using FIG. 4. FIG. 4 illustrates the functional blocks per apparatus described above. The CPU in each apparatus inside the printed image inspection system 100 executes the processing by operating each unit in each apparatus as described below.

The image processing apparatus 101, as a functional configuration, includes a print job obtaining unit 4102, a printing data generation unit 4103, and a printing data transmitting unit 4104. Note that terminals (4101, 4105) are input/output data terminals for the function of the image processing apparatus 101. The print job obtaining unit 4102 obtains a print job including submitted image data that corresponds to the target of printing and inspection. The print job is transmitted from, for example, a personal computer (not illustrated) that can communicate with the image processing apparatus 101 via the network together with a printing instruction.

The input terminal 4101 corresponds to the network I/F 206, for example. In another plausible example, a print job with predetermined print settings attached to image data in the external storage apparatus 212 may be input. In such a case, the input terminal 4101 corresponds to the general-purpose I/F 208. In another plausible example, the image processing apparatus 101 generates a print job in accordance with the print settings instructed by the user via the input apparatus 211 for the submitted image data supplied as described above. In such a case, the input terminal 4101 corresponds to the RAM 202 for providing an instruction signal or the storage apparatus 204 that supplies the image data.

The printing data generation unit 4103 receives the print job, references the submitted image information, print settings information, and the like included in the print job, executes RIP processing, and generates printing data to be transmitted to the image forming apparatus 102. The printing data transmitting unit 4104 transmits the printing data to the image forming apparatus 102 via the output terminal 4105. In this case, the output terminal 4105 corresponds to the system I/F 205, for example.

The image forming apparatus 102 includes a printing data obtaining unit 4202, a printing data processing unit 4203, an image formation drive unit 4204, and a printing data transmitting unit 4205. Note that terminals (4201, 4206) are input/output data terminals for the function of the image forming apparatus 102. The printing data obtaining unit 4202 obtains the printing data transmitted by the printing data transmitting unit 4104 via the input terminal 4201. Note that in this case, the input terminal 4201 corresponds to the system I/F 301, for example.

The printing data processing unit 4203 executes color conversion processing, half-tone (tone quantization), correction processing, and similar processing on the printing data according to the image forming characteristics of the image forming apparatus 102. Note that hereinafter, the printing data subjected to processing by the printing data processing unit 4203 according to the image forming characteristics is referred to as image formation data. The image formation drive unit 4204 drives the image forming unit 304 and prints an image on the sheet for printing on the basis of the image formation data. The printing data transmitting unit 4205 transmits the printing data or the image formation data and a signal indicating the printing has been performed to the inspection processing apparatus 103 via the output terminal 4206. Note that in this case, the output terminal 4206 corresponds to the system I/F 301.

The inspection processing apparatus 103 includes a scan data obtaining unit 4302, a scan data analyzing unit 4303 (an example of an “image processing unit”), a printing data obtaining unit 4304, and a printing data conversion unit 4305. Also, the inspection processing apparatus 103 includes an inspection processing unit 4306 (an example of a “determination unit”), an inspection result transmitting unit 4307, an inspection result storage unit 4308, an inspection result display unit 4309 (an example of an “output unit”), and a report generating unit 4310 (an example of an “output unit”). Terminals (4301, 4311) are input/output terminals for the function of the inspection processing apparatus 103. The scan data obtaining unit 4302 receives the data and signal transmitted by the printing data transmitting unit 4205 from the input terminal 4301, drives the scanning apparatus 307, and obtains scan data of the printed material. Note that in this case, the input terminal 4301 corresponds to the system I/F 306.

The scan data analyzing unit 4303 analyzes the features of the scan data. The printing data obtaining unit 4304 obtains the printing data transmitted by the printing data transmitting unit 4205. The printing data conversion unit 4305 performs resolution conversion, color conversion, or the like on the printing data obtained by the printing data obtaining unit 4304 and generates data for reference image data generation for the next inspection by the inspection processing unit 4306. The inspection processing unit 4306 executes inspection processing including generating reference image data, comparing it with scan data for inspection, and determining whether there is an abnormality in the printed material. The inspection result transmitting unit 4307 receives the inspection result of the inspection by the inspection processing unit 4306 and transmits the inspection result to the output control apparatus 104 via the output terminal 4311. Note that in this case, the output terminal 4311 corresponds to the system I/F 306. The inspection result storage unit 4308 stores and accumulates the inspection results. The inspection result display unit 4309 shows the user the inspection result stored in the inspection result storage unit 4308. The report generating unit 4310 generates an inspection report regarding all of the inspection results.

The output control apparatus 104 includes an inspection result obtaining unit 4402 and an output control unit 4403. Terminals (4401, 4404) correspond to input/output data terminals for the function of the output control apparatus 104. The inspection result obtaining unit 4402 obtains the inspection result transmitted by the inspection result transmitting unit 4307 via the input terminal 4401. The output control unit 4403 drives the control drive unit 309 on the basis of the inspection result and guides the printed material to either the printed material discharge unit 311 or the printed material housing unit 312, for example. Also, the output control unit 4403 outputs a signal indicating that processing is complete from the output terminal 4404. Note that in this case, the output terminal 4404 corresponds to the system I/F 3088.

### Processing Example 1

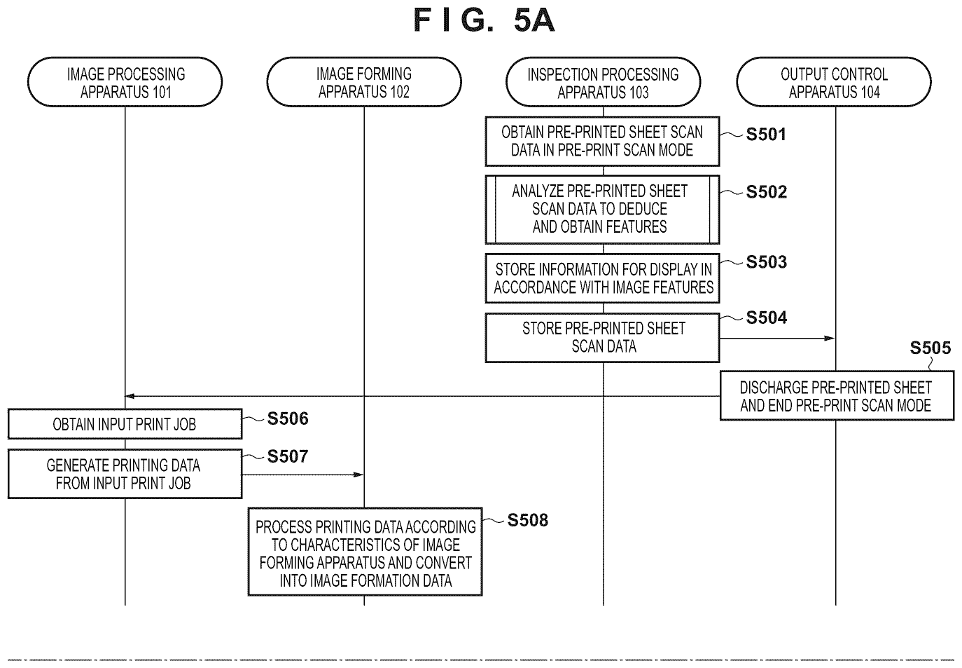

The flowchart of the sequence processing executed by the printed image inspection system 100 will now be described using FIGS. 5A and 5B. In the present embodiment, an abnormality detected in a printed image inspection is indicated at a relative position from a reference point in the image in accordance with the features of the image scanned for inspection in order to improve the ease of use for the user. In the present processing, a portion of printing is performed on the sheet for printing in advance. Note that hereinafter, the sheet for printing on which a portion of printing is performed in advance may also be referred to as a pre-printed sheet. Also, the mode of performing printing on a pre-printed sheet by the image forming apparatus 102 may be referred to as a pre-printing method. Furthermore, printing on a pre-printed sheet may be referred to as reprinting. However, the pre-printing method does not need to be used.

When printing in advance via the pre-printing method, printing of a common image element is performed on many sheets for printing. For example, a company logo may be printed on at a set position on all of the sheets for printing. A reason for performing a portion of printing in advance regardless of what image is to be printed by the image forming apparatus 102 is for cost efficiency. Specifically, the image forming apparatus 102 is an electro-photographic type, for example, but when a large volume of the same image is printed (large-volume printing), it is more cost efficient to use an offset printing method than the normal electro-photographic method. Thus, pre-printed sheets are generated by printing a common image element on many sheet for printing via the offset printing method. Then, the image forming apparatus 102 performs printing (small-volume printing) of a small volume of the same images via pre-printing. In the case of printing a relatively small volume, the electro-photographic method is more cost efficient than the normal offset printing method. In this manner, using the advantages of different printing methods, printing using the pre-printing method is performed to increase cost efficiency.

In the sequence processing illustrated in FIGS. 5A and 5B, the printed image inspection system 100 executes printing using the pre-printing method and printed image inspection processing. Note that the CPU in each apparatus in the printed image inspection system 100 reads out a program stored in the storage medium of each apparatus and controls each unit described above to implement such sequence processing.

S501 to S504 corresponds to processing in the inspection processing apparatus 103. First, in S501, the printed image inspection system 100 operates in a pre-printed sheet scanning mode, and the scan data obtaining unit 4302 obtains scan data of the pre-printed sheet. The pre-printed sheet scanning mode is one operation mode of the printed image inspection system 100 for operating on the basis of a user instruction. The printed image inspection system 100 in this mode does not perform printing on a pre-printed sheet set in the sheet supplying unit 302 by the user, and the content printed in advance on a pre-printed sheet (an example of an “image on one side of a sheet”) is scanned by the scan data obtaining unit 4302. In other words, when an operation start instruction from a user is received, the pre-printed sheet in the sheet supplying unit 302 is conveyed by the sheet conveying unit 303 and passes through the image forming unit 304 without image formation being performed. Then, the pre-printed sheet arrives as is at the scanning apparatus 307, where scan data of the pre-printed sheet (an example of a “sheet image”) is obtained. After the scanning apparatus 307, the pre-printed sheet is discharged to the printed material discharge unit 311. In this manner, the content printed in advance on the pre-printed sheet is obtained as pre-printed sheet scan data. Note that the pre-printed sheet used in this case is preferable a clean product without an abnormality.

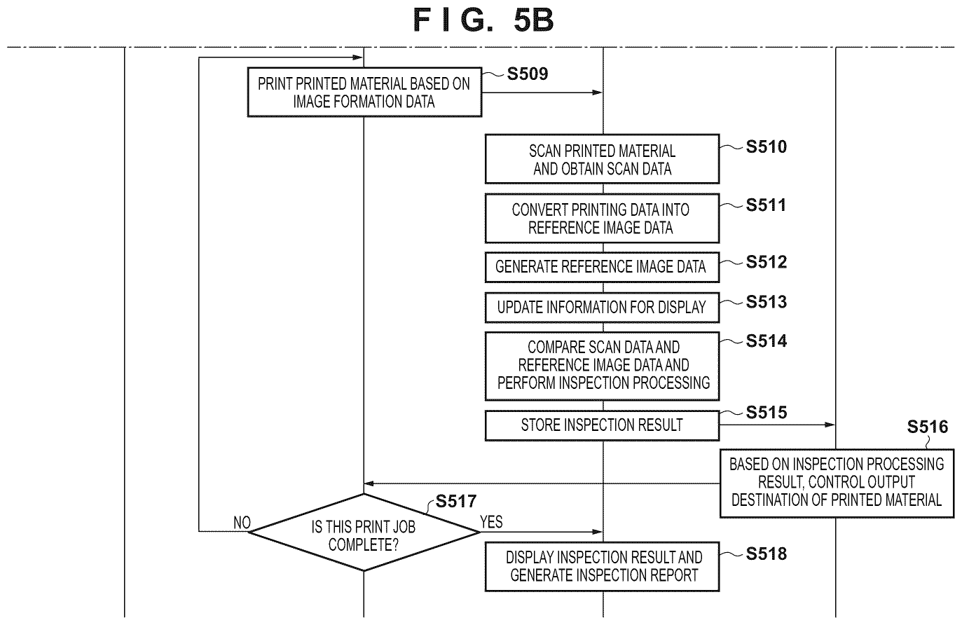

Note that in the present embodiment, printing such as that illustrated in FIG. 6 is performed in advance on the pre-printed sheet. In other words, a framework including horizontal and vertical line segments are printed as a form (cell group). A sign 601 indicates the overall pre-printed sheet, and a frame 602 indicates the form printed in advance. Note that such pre-printing may be performed by pre-printing a large volume of common forms on a business form or document, and then a small-volume printing operation may be performed while changing the specific content in the form of the printed material.

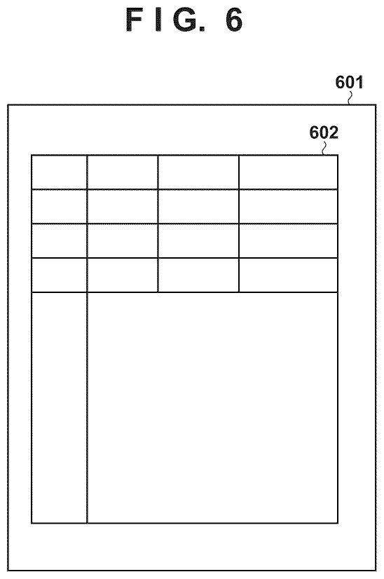

In S502, the scan data analyzing unit 4303 analyzes the pre-printed sheet scan data and deduces and obtains the features of the image. FIG. 7 illustrates a detailed flowchart of the processing of analyzing the pre-printed sheet scan data and obtaining features executed in S502. Note that the processing in FIG. 7 is also processing executed in the inspection processing apparatus 103 and is implemented by the CPU 318 in the inspection processing apparatus 103 reading out a program stored in a storage medium such as the RAM 319 and controlling each unit described above.

In S701, the scan data analyzing unit 4303 binarizes the pre-printed sheet scan data into either a drawing portion or a background portion of the image and obtains binarized data. As described above, the scan data from the scanning apparatus 307 is obtained with each pixel in an RGB 8-bit image format. Thus, binarization depending on whether each pixel value is a numerical value indicating background can be performed. For example, in the obtained binarized data, the drawing portions (the frame 602, which is a pre-printed portion) of the image are set to a pixel value of 1 and the background portions are set to a pixel value of 0.

In S702, the scan data analyzing unit 4303 calculates the feature amount of the binarized data obtained in S701. The calculations of the feature amount use a known method as the image data or, in particular, binary image data processing. In other words, contour tracking (labelling) and straight line extraction (for example, Hough transform) processing is executed with pixels with a pixel value of 1 as the target. Also, a bounding box, area (number of pixels), and the centroid are used as feature amounts. Note that bounding box refers to a rectangle that forms the boundary of at least one object on the sheet and that can enclose all of the objects inside of it.

In S703, the scan data analyzing unit 4303 deduces and obtains the features of the pre-printed sheet scan data on the basis of the feature amount obtained in S702. In the example of the present embodiment described here, the feature of the pre-printed sheet scan data is assumed to be the form type illustrated in FIG. 6. In other words, in the case of a typical form type, the frame lines forming the form are expected to form one form. Here, the entire binarized data is scanned, and when contour tracking is executed, which is processing to obtain the number and position of objects formed of a pixel value (an example of a “first value”) indicating black connected together, there is a high possibility that the detected object number stops at 1 or a low number. Note that since an object with a small area (number of pixels) may plausibly simply be noise and be meaningless in terms of an image element, such an object may be ignored.

Also, a typical form is expected to be widely spread out on the sheet surface. This is because a form that is too small is not conducive for entry and viewing. In the example of FIG. 6, the frame 602 is formed in an area that is equal to or greater than a half of the outline 601 of the entire sheet. In other words, from the objects obtained in contour tracking, an object with a large-sized bounding box enclosing an object may be considered a candidate representing a form. Then, if the form candidate is actually a form, there is a high possibility that the area of the region enclosed by the bounding box has a certain ratio or greater with respect to the sheet overall. Alternatively, there is a high possibility that the vertical and horizontal size of the bounding box has a certain ratio or greater with respect to the vertical and horizontal size of the sheet.

Also, a typical form is formed of frame lines, and the inside is expected to be left blank as an entry field. In other words, the area (number of black pixels) of the object of the form candidate has a high possibility of being small relative to the area of the bounding box and having a certain ratio or less. In addition, the line segments of a typical form include line segments in the horizontal (left and right) direction and the vertical (up and down) direction, and it is expected that there are no angles (no diagonals). Thus, with a plurality of such lines existing, a form is considered to be formed. Here, the entire binarized data is scanned, and if a Hough transform, which is processing to detect the expression of straight lines in the image, is performed, there is a high possibility of a plurality of horizontal lines and vertical lines being detected.

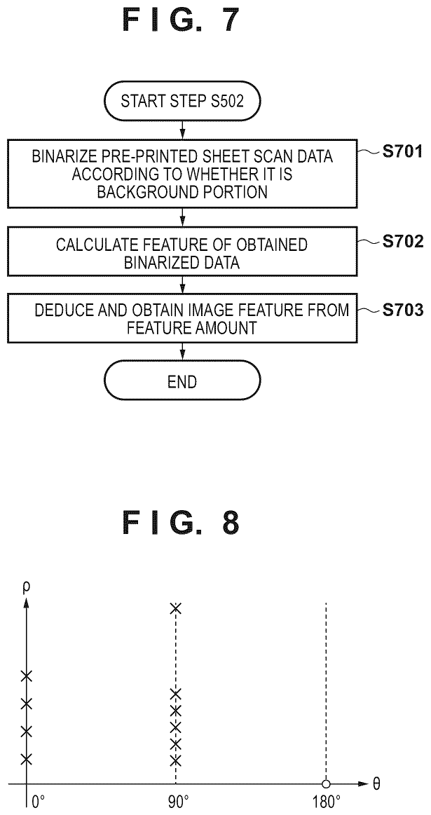

In a Hough transform, the expression of straight lines is represented as xcosθ+ysinθ=ρ, with parameters θ and ρ being used with respect to variables x and y (x being a horizontal direction variable and y being a vertical direction variable). In a Hough transform, a group of values of parameters (θ, ρ) taken in a case where each pixel with a pixel value indicating black in the binarized data is assumed to be on a straight line is tallied in a (θ, ρ) space as illustrated in FIG. 8. Since real straight line parameters get tallied from many pixels, the expression of the line segments in the image can be identified. In FIG. 8, a detection point with many tallies is indicated by an ×. In the case of a typical form, the detection points should concentrate at or near θ=0°, 90°, since the horizontal line (in other words, y=ρ) represents θ=90°and the vertical line (in other words, x=ρ) represents θ=0°. In the case of a form formed by a plurality of cells (2×2), three line segments, the frame at both ends of the region and an intermediate delimiting line, are detected. Note that a Hough transform may be restricted to a bounding box region of the form candidate instead of being performed on the entire binarized data. In summary, a condition group for determining the features of the form type in the present embodiment in S702 to S703 are as follows, for example. The condition determination starts at 1 and moves to the next condition is the condition is satisfied.

1. (Number of objects) As the result of contour tracking, the number of objects is equal to or less than a predetermined threshold Th1. For example, Th1 32 4.

2. (Spread of form) An object exists with an area of a region enclosed by a bounding box having a ratio equal to or greater than a predetermined threshold Th2 with respect to the entire sheet. This object is set as a form candidate object. For example, Th2=0.5.

3. (Empty field) A total of areas of form candidate objects (number of black pixels) has a ratio of equal to or less than a predetermined threshold Th3 with respect to the area of the region enclosed by the bounding box. For example, Th3=0.15.

4. (Horizontal and vertical lines) As the result of applying a Hough transform to the bounding box of the form candidate, three or more straight line parameters are detected at or near θ=0° and θ=90°.

In a case where an object exists which satisfies all of the above-described conditions 1 to 4, the scan data analyzing unit 4303 deduces that the pre-printed sheet scan data includes a form type feature. Note that other conditions may be added, or one or more of the above-described conditions may be omitted. For example, a line segment existing at an end region of a bounding box may be added as a condition.

After executing S703, the processing proceeds to S503 of FIG. 5A. In S503, according to the features of the pre-printed sheet scan data obtained in S502, the scan data analyzing unit 4303 identifies information for displaying this and stores the information in the RAM 319 or the like. Hereinafter, the feature of the pre-printed sheet scan data is assumed to be sorted into the form type described above. The information stored in the present embodiment is, for example, type of pre-printed sheet scan data, coordinates of the upper left of the form, form structure information, and display settings indicating displaying the abnormality position at a relative position.

The type of pre-printed sheet scan data is, for example, the feature of the pre-printed sheet scan data being a form type. The coordinates of the upper left of the form is, for example, the coordinates of a pixel value 1 furthest to the upper left of the object deduced to be a form. Alternatively, it may be the coordinates of the upper left vertex of the bounding box. The coordinates are used as a reference point when the type of a form type in the present embodiment.

Also, the scan data analyzing unit 4303 analyzes the form structure information and stores it in the RAM 319 or the like. In other words, since the expression of each straight line is known due to the Hough transform of S702, the intersection point coordinates can be made clear via calculation. If the intersection point coordinates are known, the form structure of which coordinates in the object correspond to which number cell in the form can be analyzed. In the present embodiment, the scan data analyzing unit 4303 stores the analysis result in the RAM 319 or the like as form structure information.

Note that in the case of a relatively complex structure (a state in which “cell merge” has occurred) with all of the line segments not travelling all of the way vertically or horizontally and disappearing partway, there is a possibility that the intersection points simply obtained from the expression of the straight lines may differ from that of the actual structure. Regarding this, processing may be executed to confirm whether or not the intersection point coordinates obtained via calculation are intersection point coordinates actually defining cells via template matching of the lines of intersecting images to increase the accuracy.

Also, in a case where item names or the like are included in the cells of the pre-printed sheet scan data, the cells and the item names are associated together and stored as form structure information. The item name may be recognized and stored as characters in the cell via optical character recognition (OCR) or the necessary region may be stored as an image that can be visually perceived by a human. In a case where, instead of items in cells, an adjacent cell corresponding to a key for association can be identified, the item name may be stored. Also, in S504, the scan data analyzing unit 4303 stores the obtained pre-printed sheet scan data.

In S505, the output control unit 4403 of the output control apparatus 104 discharges the pre-printed sheet to the printed material discharge unit 311 via the sheet conveying unit 303. Note that in a pre-printing scan mode, inspection processing is not executed. Then, the pre-printing scan mode ends.

From S506 onward, in the pre-printed sheet print mode, printing onto the pre-printed sheet and inspection processing are executed. Also, for inspection, the inspection processing apparatus 103 obtains the scan data obtained from scanning the printed material which is the inspection target and the reference image data which is the inspection reference.

In other words, in S506, the print job obtaining unit 4102 obtains the print job input to the printed image inspection system 100. As described above, the print job is transmitted from, for example, a personal computer (not illustrated) that can communicate with the image processing apparatus 101 via the network together with a printing instruction. In other cases, print settings may be attached to the image data in the external storage apparatus 212 by the image processing apparatus 101 and set as a print job, for example.

In S507, the printing data generation unit 4103 references the image information, the print settings information, and the like included in the input print job and executes RIP processing. Via the RIP processing, the print settings are applied and the input print job is converted to a bitmap to form printing data representing the image to be formed by the image forming apparatus 102. Then, the printing data transmitting unit 4104 transmits the printing data to the printing data obtaining unit 4202 of the image forming apparatus 102.

In S508, the printing data obtaining unit 4202 of the image forming apparatus 102 receives the printing data. Then, the printing data processing unit 4203 executes processing on the printing data in accordance with the image forming characteristics of the image forming apparatus 102 and generates image formation data. This processing includes color conversion processing, halftone processing, correction processing, and the like, for example. Typically, per device and model, the image forming apparatus includes characteristics relating to various image formation stemming from the color material and devices used. The image formation data generated in S508 is data for image formation by the image forming unit 304 based on a difference between the printing data and the image forming characteristics after this difference is resolved.

Specifically, the color conversion processing converts the colors represented by the image of the printing data into color material amount to be used in image formation. In the present embodiment example, the color material used by the image forming unit 304 is toner, and four colors, cyan (C), magenta (M), yellow (Y), and black (key plate, K) are used. The color material is determined by a three-dimensional, four-dimensional, or one-dimensional look-up table (LUT) indicating the conversion relationship between the color and the color material amount obtained as the image forming characteristics in advance. Halftone processing is executed in order to quantize the image of the printing data represented by multiple-value pixel values into smaller numerical values (for example, a binary value that represents the presence or absence of toner at a pixel position) that the image forming apparatus 102 can direct express. For this, a dither method or an error diffusion method may be used, for example. The correction processing is processing to perform edge enhancement for treating an image characteristic such as a sharp edge not being fully reproduced with the image forming apparatus 102, for example. In this processing, an edge enhancement filter is used, for example. These various types of processing are executed, and image formation data is generated from the printing data.

In S509, the image formation drive unit 4204 drives the image forming unit 304 and prints an image on the pre-printed sheet conveyed along the sheet conveying unit 303 on the basis of the image formation data. With an electro-photographic method, the toner amount set in the image formation data is held in the form of an image on the photosensitive drum via voltage control. After the toner is transferred to the sheet for printing, the toner is fixed to the sheet for printing to form the printed material. Then, the printing data transmitting unit 4205 transmits the printing data or image formation data to the inspection processing apparatus 103. Also, the printing data transmitting unit 4205 transmits a signal indicating that printing has been performed to the inspection processing apparatus 103. Note that in the flow described below, data transmitted to the inspection processing apparatus 103 is printing data not subjected to image processing by the printing data processing unit 4203. However, this is also applicable in cases where the data is post-image-processing image formation data and where the data is both printing data and image formation data.

In S510, the printing data obtaining unit 4304 of the inspection processing apparatus 103 receives the printing data and the signal indicating that printing has been performed. Also, the scan data obtaining unit 4302 drives the scanning apparatus 307, scans the printed material (an example of an “image of one side of the sheet”) conveyed along the sheet conveying unit 303, and obtains scan data (an example of a “sheet image”). The scan data here is an image with each pixel having RGB 3 channels and 8-bit per channel as described above. In S511, the printing data conversion unit 4305 executes conversion processing on the printing data and generates a portion of the reference image data in the inspection performed by the inspection processing unit 4306. This conversion includes resolution conversion processing, color conversion processing, and the like, for example. Note that the reference image data is image data representing a printed product without abnormalities. Note that “one side of the sheet” refers to one side of the printed material conveyed along the sheet conveying unit 303, and “sheet image” refers to an image obtained by scanning this “one side of the sheet”. Also, in the case of a pre-printing method, one side of the pre-printed sheet is also an example of one side of the sheet, and the scan data obtained by scanning this is an example of a “sheet image”.

In inspection processing, the reference image data and the scan data obtained by scanning the printed material which is the inspection target are compared. Since the printing data does not include an abnormality, at this point in time, the printing data is suited to be used as the reference image data. However, in some cases, the scan data and the printing data are not suited to be used in comparison. One reason is that though the scan data includes an image printed in advance on the pre-printed sheet, the printing data does not include information of the image printed in advance. In other words, the pre-printed data and the printing data need to be merged, as will be described next in S512. Accordingly, the data generated in S511 corresponds to a portion of the reference image data.

A second reason is because of a difference in the image format. For example, the scan data is RGB 3 channel. However, since the image forming apparatus 102 uses toner of the four colors CMYK, the printing data is not limited to being RGB 3 channel and is often CMYK 4 channel. Also, the image resolution of the scan data is determined by the conveyance speed of the sheet conveying unit 303 and the scan frequency of the scanning apparatus 307, but the image resolution may have no relationship to the printing processing system. Thus, the image resolution of the scan data and the printing data do not always match. Here, in S511, this difference is resolved, and (a portion of) reference image data suitable for comparison with the scan data is generated.

The resolution conversion processing executed in S511 is resolution conversion to make the printing data match the resolution of the scan data. Alternatively, instead of making the resolution match the resolution of the scan data, any inspection resolution at which an abnormality can be sufficient captured and the image size does not become excessive may be matched. Also, the color conversion processing executed in S511 is executed via conversion using a LUT that describes the pixel value relationship between the printing data and the scan data. In this LUT conversion, a correspondence relationship indicating that the pixel values in the printing data are respectively recorded in the pixel values in the read data is measured through printing and reading, and the measurement result is converted into an LUT in advance. Also, the image forming characteristics of the image forming unit 304 and the scanning characteristics of the scanning apparatus 307 are added to the scan data. Here, correction processing in which these characteristics are simulated and added to the printing data may be executed. In this manner, a portion of the reference image data is obtained from the printing data. Note that in a case where the printing data transmitting unit 4205 transmits the image formation data, instead of the printing data, the image formation data may be subjected to conversion such as that described above to form a portion of the reference image data.

In S512, the inspection processing unit 4306 reads out the pre-printed sheet scan data stored in S504, combines the data with the portion of the reference image data generated in S511, and generates reference image data to use in inspection. For example, after alignment processing of both images using the four corners of the sheets, one image may be superimposed on the other acting as a base and then combined. In the alignment processing, a projective transformation matrix may be used, for example. Also, the reference image may be generated using alpha blending of both images, for example. This method is effective in cases where there is overlap in printing.

In S513, the inspection processing unit 4306 reads out the information for display stored in S503 and updates the information for display if there is updated information relating to this. In other words, according to the present embodiment, in a case where there are no items in the cells of the pre-printed sheet scan data, items are considered to be in the printing data. Thus, as in S503, in a case where item names and the like are included in the cells of the printing data, the cells and the item names are associated together and the inspection processing unit 4306 stores these in the RAM 319 or the like to update the information for display. In S514, the inspection processing unit 4306 executes inspection processing to confirm whether or not the printing unit is abnormal by comparing the scan data and the reference image data. Note that in S514, preprocessing before the inspection processing is included. Specifically, preprocessing includes resolution conversion processing to make the image resolution of the scan data and the reference image data the same and alignment processing to align the position of both images.

The resolution conversion processing matches the resolution of the reference image data in a case where the reference image data is generated at an image resolution different from that of the scan data. The alignment processing makes the position and inclination of the reference image and the scanned image the same. In other words, in the reference image data generated from the printing data, the image is the right way up and at the reference position. However, in the present printing, when many sets are printed, the printed sheets are conveyed at high-speeds. Thus, in a case where an image is printed on such a sheet for printing, depending on the accuracy of the image formation and sheet conveyance, the image is not always printed strictly at the same position and inclination. Thus, there is a possibility of errors in alignment and inclination are included in the scan data obtained by scanning such printed material. If errors in alignment and inclination exist, the data is not suitable for comparison with the reference image data. Thus, alignment processing is executed to resolve the errors in alignment and inclination.

In the alignment processing, a projective transformation matrix using the four corners of the sheets may be used as in S512 described above. Alternatively, since the scan data and the reference image data include the same design, in the alignment processing, a feature point of the image may be used. Specifically, the inspection processing unit 4306 executes feature point extraction processing (for example, AKAZE or a similar method) using both images and obtains the corresponding points of both pieces of image data. Also, the inspection processing unit 4306 obtains a conversion expression (projective transformation matrix) to match the corresponding points and performs conversion to correct the misalignment in both images.

When such preprocessing ends, the inspection processing unit 4306 performs a comparison per pixel of the reference image data and the scan data. If the scan data has no abnormalities and substantially matches the reference image data, the difference will be kept in the range of a small value near 0. However, if an abnormality is recorded in the scan data, a large difference in absolute values will occur at that portion. Typical examples of abnormalities include a circular abnormality (also referred to as a “spot”) caused by color material adhering to an unintended section at the time of printing, an abnormality (“color loss”) caused by color material not sufficiently adhering to an intended section, a linear abnormality (“streak”), and the like. If there is such an abnormality, pixels with a large difference in absolute values are produced, with the pixels being grouped together to some extent per abnormality type. The inspection processing unit 4306 extracts the abnormal section by applying spatial filter processing of a predetermined shape to the difference, comparing the response value of the spatial filter and a predetermined threshold, and determining whether or not to treat the difference as an abnormality. In this manner, the inspection processing unit 4306 determines whether or not there is an abnormality in the scan data.

In S515, the inspection result storage unit 4308 stores the inspection result obtained in S514. Specifically, the page where the abnormality occurred, the abnormality type, and the position of the abnormality are stored. Also, the inspection result storage unit 4308 performs an analysis for displaying the abnormality in accordance with the image feature and storing thereof. The processing will be described below in detail together with the display of the abnormality (S518). Then, the inspection result transmitting unit 4307 transmits the inspection result to the output control apparatus 104.

In S516, the inspection result obtaining unit 4402 of the output control apparatus 104 receives the inspection result. Then, the output control unit 4403 drives the control drive unit 309 in accordance with the inspection result and guides the printed material conveyed along the sheet conveying unit 303 to the conveying destination (either the printed material discharge unit 311 or the printed material housing unit 312). In other words, the output control unit 4403 performs control of the sheet conveyance so that the printed material is guided to the printed material housing unit 312 in the case of an inspection pass and to the printed material discharge unit 311 in the case of an inspection fail.

In S517, the CPU 313 of the image forming apparatus 102 determines whether or not printing of the number of copies designated in the print job has been completed. Note that the information of the number of copies is included in the printing data received from the image processing apparatus 101 in S507. In a case where printing of the designated number of copies is not complete, the processing returns to S509, and the processing of S509 to S516 is repeated until printing of the designated number of copies is complete. On the other hand, in a case where the CPU 313 determines that printing of the number of copies designated in the print job is complete, the processing proceeds to S518.

In S518, the inspection result display unit 4309 of the inspection processing apparatus 103 receives information of the inspection result from the inspection result storage unit 4308 and displays to the user the inspection result, in particular, the abnormality information, via the inspection UI panel 308. Also, the report generating unit 4310 receives the information of the inspection result from the inspection result storage unit 4308 and generates an inspection report relating to the inspection result. The displayed abnormality information and the displayed inspection report includes information of the overall job inspection results including the total number of times printed, the number of passed products, the number of failed products, and the like. Regarding failed products, the position of the abnormality, the type, and the actual appearance of the abnormality as proof are indicated by referencing the scan data. Note that for comparison, the scan data as well as the reference image data may be referenced.

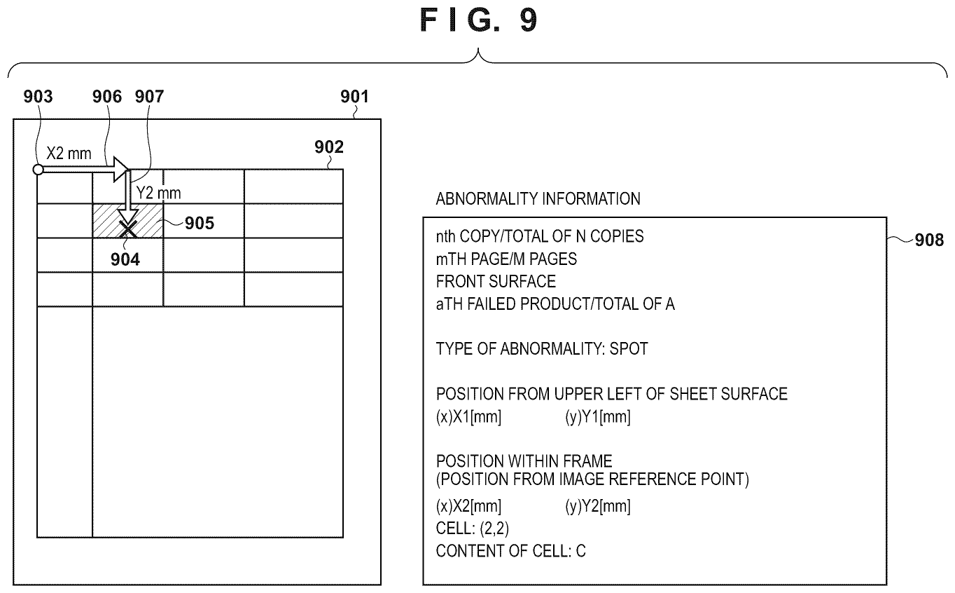

The inspection result displayed on the inspection UI panel 308 by the inspection result display unit 4309 in S518 will now be described using FIG. 9. In FIG. 9, a frame 901 indicate the entire sheet of the scan data. Note that the frame 901 corresponds to the outline 601 of the sheet in the pre-printed sheet in FIG. 6. A frame 902 is a form printed in advance and corresponds to the frame 602 in FIG. 6. A point 903 is a reference point in the present embodiment located at the upper left vertex of the form which is one piece of information for display obtained in S503. Note that the scan data includes not only the form actually pre-printed on the pre-printed sheet but also the image (reprinting image) printed in S509. In a display example according to the present embodiment, the reprinting image is actually included, but the reprinting image is omitted in FIG. 9 to simplify the diagram. In this example, a “spot” abnormality has been detected at an ×mark 904 in FIG. 9. Also, the coordinates from the upper left of the sheet surface of the detection position is (X1, Y1) (unit: millimeters). Note that hereinafter, the X direction is defined as the horizontal direction on the display screen, and the Y direction is defined as the vertical direction.

In the present embodiment, in S515, the inspection result storage unit 4308 analyzes the abnormality information for display of the abnormality position in accordance with the image feature and stores this information. Specifically, the inspection result storage unit 4308 calculates and obtains the relative coordinates of the abnormality based on the reference point 903 in the image. Note that the relative coordinates in this case are (X2, Y2) (unit: as above). Also, the inspection result display unit 4309 identifies and obtains which cell the abnormality position corresponds to from the information for display obtained in S503. Note that at the time of the inspection processing of S514, in a case where alignment on both images is performed after detecting misalignment between the scan data and the reference image data, the inspection result display unit 4309 also corrects the position of the corresponding cell. Also, as illustrated in FIG. 9, the corresponding cell corresponding to the section where the abnormality occurred is cell (2, 2) indicated by a region 905 using the upper left of the image as the reference point. Also, the inspection result display unit 4309 identifies and obtains the item name associated with the corresponding cell. In S515, the obtained information is stored together with the inspection result.

Also, the inspection result display unit 4309 displays an arrow 906 in the horizontal direction and an arrow 907 in the vertical direction indicating the position of the abnormality from the reference point 903. Note that the arrow 906 and the arrow 907 are examples of “relative position information indicating a relative position” and a “display element”. Also, the arrow 906 is an example of a “line segment parallel with the left-and-right direction”, and the arrow 907 is an example of a “line segment parallel with the up-and-down direction”. Also, the inspection result display unit 4309 displays the position information (X2 mm, Y2 mm) together at the arrows (an example of a “display element”). The inspection result display unit 4309 displays the corresponding cell (2, 2) in a color to allow it to be identified from other cells as the region 905 (an example of a “display element”). Also, the inspection result display unit 4309 displays an abnormality information display field 908 (an example of a “display element”). In the abnormality information display field 908, the inspection result stored in the RAM 319 or the like by the inspection result storage unit 4308 in S515, that is, abnormality information including the page where the abnormality occurred, the abnormality type, the position of the abnormality, and the like is displayed.

Specifically, n, N, m, M, a, and A in the abnormality information display field 908 are symbols in the diagram and are actually represented by numerical values. Also, “front surface” in the display field represents a distinction between front and back surface of the printed material which is the inspection target. For the position of the abnormality, the relative coordinates (X1, Y1) in a case where the upper left vertex of the frame 901 is the origin are displayed together with the relative coordinates (X2, Y2) from the reference point 903. Also, (2, 2) which is the corresponding cell position information is displayed. Furthermore, the item name associated with the cell which is the information for display is displayed as “cell content”. Note that C is a symbol in the diagram and is actually represented by a character string or the like indicating an item. Note that the inspection result display unit 4309 may display the information illustrated in the abnormality information display field 908 superimposed on the frame 901 without separating displaying it as a field. Note that the absolute coordinates (X1, Y1) are an example of “absolute position information indicating the absolute position”.

The report generating unit 4310 generates an inspection report using an abnormality position display method in a similar manner to the inspection result display unit 4309. Also, the report generating unit 4310 stores the generated report in a storage medium such as the RAM 319 or the like of the inspection processing apparatus 103 in a manner allowing the user to reference the report.

### Advantages and Effects of Aspect

According to the printed image inspection system 100 as described above, whether or not a printed material has an abnormality can be automatically determined and only the printed products with no abnormalities can be collected. Also, the color of the cell at the position where the abnormality occurred is displayed in a different color to the other cells. Thus, the user can roughly comprehend the position in the entire sheet where the abnormality occurred. Also, the position information of where the abnormality occurred is displayed in a concise manner as relative position information relative to a reference point. Thus, the user can identify in detail the position where the abnormality occurred from among the regions roughly comprehended. In other words, according to the printed image inspection system 100 as described above, the absolute position and the relative position of the place where the abnormality occurred are displayed in a complementary manner. Thus, the user is assisted in smoothly confirming the abnormality position, allowing a significant effect of improving the ease of use for the user to be achieved.

Specifically, the user references the abnormality information display or the inspection report, actually confirms the abnormality, and confirms the actual quality of the printed product to confirm the type of the abnormality. For example, it is expected that even if an abnormality is just over the determination threshold and determined as a very minor abnormality, it may be a quality standard that is tolerable when a human actually looks at it. Also, there are expected to be cases where deposits (dust) are temporarily present at the time that the scan data is obtained, causing an abnormality to be determined irrespective of this and cases where deposits can be easily removed. In such cases, since a printed product that should pass is excluded as an abnormal product, waste in terms of sheets for printing, color material, and time for re-printing is caused. Regarding this, if a product determined as abnormal is checked and confirmed to have no abnormalities in terms of quality, the product may be set to as passed product.

Also, the user confirms the state of the image forming apparatus 102 by referencing the abnormality information display or the inspection report. In a case where major abnormalities are continually confirmed, there is a high possibility that an abnormality has occurred in the image forming apparatus 102, and if printing is continued as in, many abnormal products will be output. Regarding this, to identify the cause of the abnormality, the abnormality is confirmed and the state of the image forming apparatus 102 is checked, and depending on the state, a determination is made to perform calibration or request for maintenance service. Also, the state of a sample determined to be abnormal may be confirmed, and from this state, an operation such as adjusting the inspection level of the subsequent inspection can be performed. Since the abnormality information display or inspection report described above can be used to smoothly confirm the abnormality position, the ease of use of the user that actually performs the task of confirming the quality of the printed product and confirming the state of the image forming apparatus 102 can be improved.

In the case of the form type, it is expected that many listed contents exist in the frames of the form. Regarding this, placing the reference point at an end point (upper left coordinates) of the form type and indicating the abnormality position by the relative position from the reference point indicates that the abnormality position is meaningfully indicated with coordinate values in the image excluding the margin. Thus, the abnormality position can be indicated with numerical values in a range which is sufficient and necessary. In other words, the abnormality position can be indicated with more concise numerical values in the coordinate system described above in which X1>X2 and Y1>Y2. Also, displaying the corresponding cell in color helps the abnormality position to be intuitively comprehended. Also, in a similar manner, displaying the item name of the cell helps a user who knows the form structure to intuitively comprehend the abnormality position. Also, the item name of the cell also is a hint indicating whether or not the content printed in the form is correct. Displaying such a hint makes it easier for the user to roughly identify the position in a case where the scan data and the abnormality position is displayed, without needing to display the entire image of the scan data. Note that the method of displaying the abnormality position using the relative position from the reference point may be switched to a display method indicating the abnormality position using the absolute coordinates on the sheet.

### First Modification Example

In the embodiment described above, the inspection target is a sheet printed with a form type image. However, in the first modification example, the inspection target is a sheet printed with an image including another feature. Note that configurations similar to that of the embodiment described above will be given the same reference sign and descriptions thereof will be omitted. Also, the processing labelled with a step number that is the same as in the embodiment described above is executed by the same component unit as in the embodiment described above. Also, for sequence processing according to the first modification example, the CPU in each apparatus in the printed image inspection system 100 reads out a program stored in the storage medium of each apparatus and controls each unit described above to implement such sequence processing.

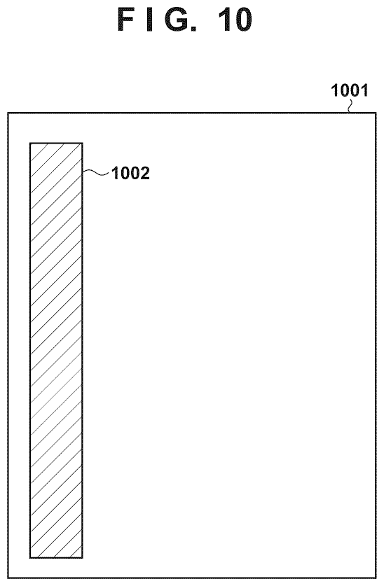

A pre-printed sheet according to the first modification example will now be described using FIG. 10. A pre-printed portion 1002 extending vertically is pre-printed on the left side of a frame 1001 representing the entire sheet on the pre-printed sheet according to the first modification example. Such pre-printing is performed in a case where the right side of the pre-printed portion 1002 is left blank for a main image and the pre-printed portion 1002 is a fixed sub-image. The main image is printed in small volumes with the content changing, and the common sub-image is printed in advance in large volumes via pre-printing. Note that the pre-printed portion 1002 is not necessarily drawn in the entire region illustrated in the diagram and may include a background portion inside. In the case of this type, the common pre-printed portion 1002 is offset to one side of the sheet (an example of a “predetermined side”) and drawn extending vertically. This can provide a hint as to the position by acting as a ruler with respect to the main image. Note that this type may also be referred to below as a ruler type.

In the first modification example, as in the embodiment described above, in S701, the scan data analyzing unit 4303 obtains binarized data, in S702, the feature amount of the binarized data is calculated, in S703, the feature of the pre-printed sheet scan data is deduced and obtained on the basis of the feature amount calculated in S702. In the deducing method described hereinafter, whether or not the feature of the pre-printed sheet scan data is a ruler type as illustrated in FIG. 10 is deduced.

In the case of a typical ruler type, it is expected that the majority of the sheet including the central portion is left blank for the main image. In other words, there is a high possibility of a bounding box circumscribing all of the objects being biased to one portion of the sheet surface. FIG. 10 illustrates an example in which the bias is to the left side of the sheet surface. Here, a determination condition for a ruler type in this case includes the vertex coordinates on the right side of the bounding box being equal to or less than a certain value with respect to the sheet surface wide. Next, as a ruler type, to provide an appropriate hint to the user as to the position where the abnormality occurred, the pre-printed portion 1002 preferably extends in the direction perpendicular to the direction is exists. In the example of FIG. 10, the pre-printed portion 1002 extends in the up-and-down direction perpendicular to the left side direction. Here, the determination condition for a ruler type includes the height of the bounding box being equal to or greater than a certain ratio with respect to the sheet surface height.

Also, the determination condition for a ruler type includes an object in the region of the pre-printed portion 1002 being drawn at a certain proportion or greater. In other words, the two determination conditions described above include a possibility of objects existing separate from one another at both ends (up/down, left/right, diagonal line) forming the bounding box and much of the inside of the bounding box being a background portion. Regarding this, a condition is further set of the area of the objects included in the area of the bounding box being equal to or greater than a certain ratio with respect to the area of the bounding box. To summarize, the condition group of type determination for ruler type in S702 to S703 according to the first modification example are as follows, for example. However, note that thresholds and the like are omitted.

1. (Biased in one direction) As a result of contour tracking, a bounding box including all of the objects is biased in one direction. This allows for determination from the width and height of the bounding box and the coordinate values of the vertices.

2. (Spread in a different direction) The bounding box including all of the objects extends in a direction perpendicular to the existing direction of the object with respect to the sheet surface. This allows for determination from the width and the height of the bounding box.

3. (Drawing inside region) The area of the object included in the bounding box is equal to or greater than a certain proportion of the area of the bounding box including all of the objects.

In a case where all of the conditions are satisfied, the feature of the pre-printed sheet scan data is deduced to be a ruler type. Note that other conditions may be added, or one or more of the above-described conditions may be omitted. For example, in order for the pre-printed portion 1002 to be a hint for the position like a ruler, the pre-printed portion 1002 preferably is non-uniform and includes a design. To detect the pre-printed portion 1002 such as this, the scan data analyzing unit 4303 may reference the pixel values of the pre-printed sheet scan data corresponding to the region of the pre-printed portion 1002 and may calculate the feature amount. Here, the feature amount for confirming a non-uniform image is, for example, variance in pixel values or frequency analysis values.

In S503, the scan data analyzing unit 4303 identifies and stores the information for display. The information stored in the first modification example is the type of the pre-printed sheet scan data and information of the ruler structure. The type of pre-printed sheet scan data is the feature of the pre-printed sheet scan data being a ruler type. The information of the ruler structure is coordinates (four points) of the pixel closest to each vertex of the bounding box from among the pixels with a pixel value of 1 in the pre-printed portion 1002.

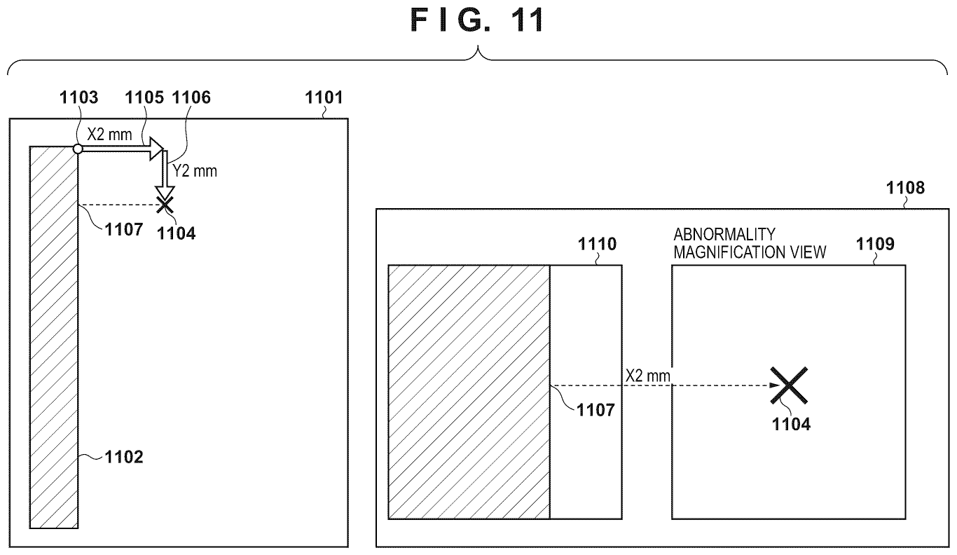

The abnormality information of the inspection result displayed on the inspection UI panel 308 by the inspection result display unit 4309 in S518 according to the first modification example will now be described using FIG. 11. A frame 1101 illustrated in FIG. 11 indicates the entire sheet of the scan data. This corresponds to the frame 1001 indicating the entire sheet of the pre-printed sheet illustrated in FIG. 10. A pre-printed portion 1102 corresponds to the pre-printed portion 1002 in FIG. 10. As in FIG. 9, the image printed in S509 is not illustrated. A point 1103 is the upper right point of the information of the ruler structure, which is one piece of information for display obtained in S503 and is defined as the reference point placed in the image. In this manner, from among the vertices of the four pixels which are information of the ruler structure, the vertex closest to the center of the image on the upper side is determined as the reference point.

In this example, a “spot” abnormality has been detected at a position indicated by an ×mark in FIG. 11. The inspection result display unit 4309 instructs as to relative coordinates (X2, Y2) from the reference point 1103 to an abnormality position 1104 using an arrow 1105 in the horizontal direction and an arrow 1106 in the vertical direction. Also, the inspection result display unit 4309 displays the position information (X2 mm and Y2 mm) together at the arrows. A point 1107 is a position on the ruler including the same Y coordinate component as the abnormality position 1104. The inspection result display unit 4309 also displays an abnormality preview field 1108. In the abnormality preview field 1108, an enlarged image 1109 at or near the abnormality position 1104 and an enlarged image 1110 at or near the point 1107 are displayed (an example of “enlarged display”). Also, in S518 according to the first modification example, the report generating unit 4310 generates an inspection report using an abnormality position display method in a similar manner to the inspection result display unit 4309.

### Advantages and Effects of Aspect

As described above, according to the printed image inspection system 100 according to the first modification example, the pre-printed sheet data is analyzed, information relating to the ruler type is obtained and used in displaying the abnormality position. In the case of a ruler type, it is expected that the main image is printed in the space left blank by the pre-printed portion 1102. Here, the abnormality position is indicated using the relative position from a reference point, the reference point being placed at a position near the abnormality from among the end points of the pre-printed portion 1102 corresponding to a ruler. Thus, the abnormality position can be indicated with more concise numerical values. Also, since the pre-printed portion 1002 is a common portion printed in high volumes, displaying the position on the ruler (pre-printed portion 1102) corresponding to the abnormality position in the abnormality preview field 1108 provides the user a hint to intuitively comprehend the abnormality position more than a case where coordinate values are used. Thus, according to the first modification example, assistance can be provided to make it easier for the user to confirm the abnormality position from a display of the abnormality information or the inspection report.

Note that in the first modification example, an example in which the pre-printed portion 1002 is biased to the left side has been described. However, the pre-printed portion 1002 may be biased in any direction including up, down, left, and right. Also, for the reference point according to the first modification example, the point closest to the center of the image on the upper side is selected from among the four end points of the pre-printed portion 1102, which is information for display. A reason for selecting the point on the upper side is because it is thought that in images, the top left is often used as the origin, and this coordinates direction is customary. Also, a reason for selecting the point closest to the center of the image is because the abnormality position is indicated in a range which is more sufficient and necessary. However, the reference point selection method is not limited thereto. For example, from among the four end points of the pre-printed portion 1102, which is information for display, the point closest to the abnormality position may be selected.

### Second Modification Example

As in the first modification example, the second modification example described herein is an example in which the inspection target include another feature. Note that configurations similar to those described above will be given the same reference sign and descriptions thereof will be omitted. Also, the processing labelled with a step number that is the same as in the embodiment described above is executed by the same component unit as in the embodiment described above. Also, for sequence processing according to the second modification example, the CPU in each apparatus in the printed image inspection system 100 reads out a program stored in the storage medium of each apparatus and controls each unit described above to implement such sequence processing.

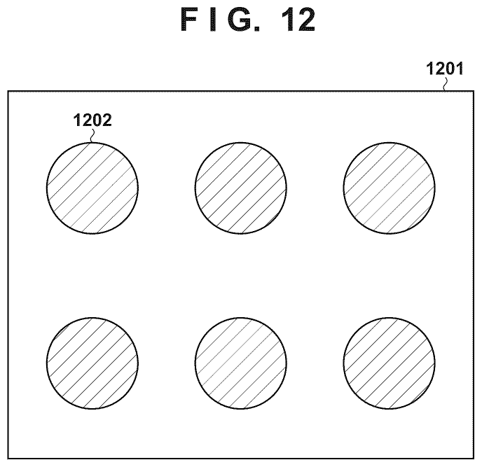

The pre-printed sheet according to the second modification example will now be described using FIG. 12. Printing such as that illustrated in FIG. 12 is performed in advance on the pre-printed sheet scanned in S501 according to the first modification example. In other words, a plurality of pre-printed portions 1202 with a circular shape are printed in advance in a frame 1201 indicating the entire sheet. The pre-printed portions 1202 represent a repeating pattern (an example of a “array”), and it is assumed that reprinting images are printed overlapping the pre-printed portions 1202. The pre-printed portion 1202 may be a logo of a companies or a group or the like, for example. This shape will hereinafter be referred to as a pattern type. Note that the arrangement of the pre-printed portions 1202 is fixed.

In the second modification example, as in the embodiments described above, in S701, the scan data analyzing unit 4303 obtains binarized data, in S702, the feature amount of the binarized data is calculated, the feature of the pre-printed sheet scan data is deduced and obtained on the basis of the feature amount calculated in S703. In the deducing method described hereinafter, whether or not the feature of the pre-printed sheet scan data is a pattern type as illustrated in FIG. 12 is deduced.

In the case of a typically pattern type, the same design is repeated. In other words, if the contour tracking processing is executed on the binarized data, there is a high possibility of a plurality of objects including substantially the same area and bounding box being obtained. Next, as the pattern type, preferably each obtained object is arranged in a regular manner. An example of a reason for this is whether or not it is a pattern type can be determined by the coordinate values of the centroid of the pixels indicating black from among each binarized pixel binarized of each object being calculated and these coordinate values being compared. In other words, in a case where the vectors between centroids of objects with the shortest distance between them is substantially the same vector, it can be determined that there is a high possibility that each object is arranged in a regular manner. Thus, the condition group of type determination for pattern type in S702 to S703 according to the second modification example are as follows, for example.

1. (Plurality of objects of the same type) As the result of contour tracking, a plurality of objects with similar area and bounding box are obtained.

2. (Regular arrangement) The difference in coordinates of the centroid of objects with the shortest distance between them can be expressed by a substantially constant vector.

In a case where all of the conditions described above are satisfied, the scan data analyzing unit 4303 deduces that the pre-printed sheet scan data includes a pattern type feature. Note that other conditions may be added, or one or more of the above-described conditions may be omitted. For example, a condition that the area of each object is not too small or too large may be applied, and the distances relating to the centroids as well as the bounding box may be compared. Also, that objects are a similar shape may be ensured via template matching or the like.

Also, in S503 according to the second modification example, the scan data analyzing unit 4303 identifies the information for display and stores the type of the pre-printed sheet scan data and the information of the pattern structure. The type of pre-printed sheet scan data is the feature of the pre-printed sheet scan data being a pattern type. The information of the pattern structure is the centroid position of each object, the vertex positions of the bounding box, and the position of the reference point. The reference point is set per object and a plurality exist. In other words, the coordinates of the left-most pixel (with the smallest x coordinate) of a region with a pixel value of 1 corresponding to each object is set.

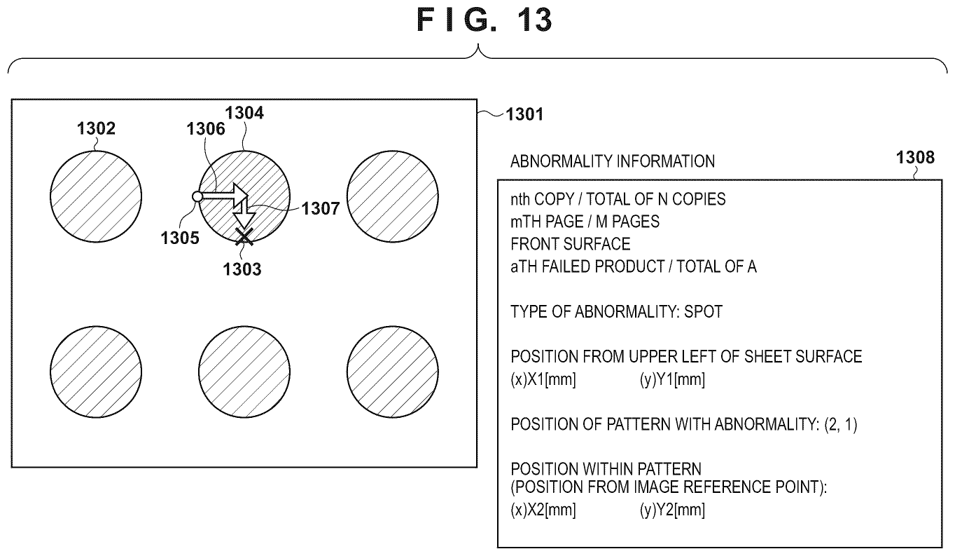

The abnormality information of the inspection result displayed on the inspection UI panel 308 by the inspection result display unit 4309 in S518 according to the second modification example will now be described using FIG. 13. A frame 1301 illustrated in FIG. 13 indicates the entire sheet of the scan data. This corresponds to the frame 1201 indicating the entire sheet of the pre-printed sheet illustrated in FIG. 12. A pre-printed portion 1302 corresponds to the pre-printed portion 1202 in FIG. 12. Note that as in FIG. 9, the image printed in S509 is not illustrated. In this example, a “spot” abnormality has been detected at a position indicated by an x mark in FIG. 13. The detection position is within the bounding box of a pattern 1304. Note that a point 1305 is a reference point in the pattern 1304 including the abnormality in its bounding box.

The inspection result display unit 4309 instructs as to relative coordinates (X2, Y2) from the reference point 1305 to an abnormality position 1303 using an arrow 1306 in the horizontal direction and an arrow 1307 in the vertical direction. Also, the inspection result display unit 4309 displays the pattern 1304 where the abnormality position exists in a different color to the other patterns. Also, the inspection result display unit 4309 displays an abnormality information display field 1308. In the abnormality information display field 1308, for what pattern number in the frame 1301 of the scan data is the pattern 1304 including the abnormality in its bounding box, (2, 1) is displayed meaning that it is the second pattern in the X direction and the first pattern in the Y using the top left of the entire sheet as the reference (1, 1). Such a display can be derived from the coordinates of each centroid of the patterns arranged in a regular manner being known.

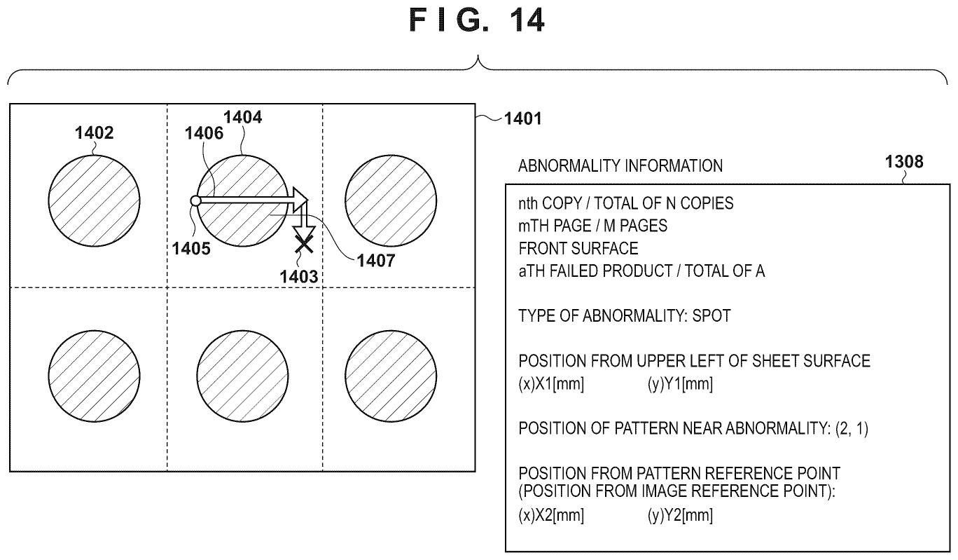

The mode of display of the abnormality position in a case where the abnormality detection position is not inside a bounding box of a pattern will now be described using FIG. 14. Note that the signs illustrated in FIG. 14 are substantially the same as the signs in FIG. 13. Thus, only differences will be described. A position 1403 of an abnormality is not included inside the bounding box of any pattern 1402. In such a case, the coordinates of the left-most pixel (with the smallest X coordinate) in the pattern with the closest centroid is selected as the reference point. Note that the dashed line in FIG. 14 is illustrated to make clear the pattern including the reference point. Note that since the abnormality does not exist in a pattern in FIG. 14, a pattern 1404 is not displayed in a color different from the other patterns. Also, the report generating unit 4310 generates an inspection report using an abnormality position display method in a similar manner to the inspection result display unit 4309. According to the second modification example, in this manner, similar effects to that of the embodiments described above are achieved.

### Third Modification Example

As in the first modification example, the third modification example described herein is an example in which the inspection target include another feature. Note that configurations similar to those described above will be given the same reference sign and descriptions thereof will be omitted. Also, the processing labelled with a step number that is the same as in the embodiment described above is executed by the same component unit as in the embodiment described above. Also, for sequence processing according to the third modification example, the CPU in each apparatus in the printed image inspection system 100 reads out a program stored in the storage medium of each apparatus and controls each unit described above to implement such sequence processing.

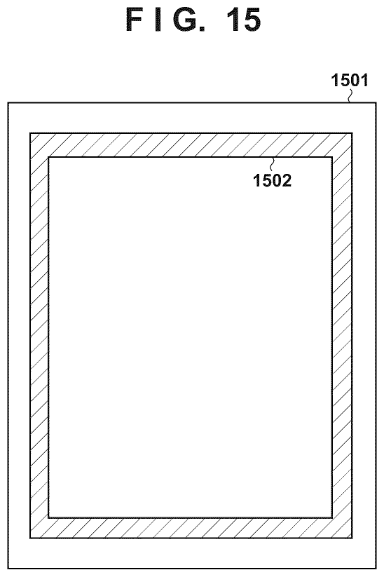

The pre-printed sheet according to the third modification example will now be described using FIG. 15. Printing such as that illustrated in FIG. 15 is performed in advance on the pre-printed sheet scanned in S501 according to the third modification example. In other words, a plurality of pre-printed portions 1502 are printed in advance in a frame 1501 indicating the entire sheet. The pre-printed portion 1502 exists along the four sides of the peripheral portion of the sheet for printing (an example of a “frame shape” or “rectangle”), and it is assumed that printing on the pre-printed sheet is performed inside the pre-printed portion 1502 in the blank space. The pre-printed portion 1502 may be a document decoration or the like, for example. This shape will hereinafter be referred to as a frame type.

In the third modification example, as in the embodiments described above, in S701, the scan data analyzing unit 4303 obtains binarized data, in S702, the feature amount of the binarized data is calculated, the feature of the pre-printed sheet scan data is deduced and obtained on the basis of the feature amount calculated in S703. In the deducing method described hereinafter, whether or not the feature of the pre-printed sheet scan data is a frame type as illustrated in FIG. 15 is deduced.

In the case of a typical frame type, as with a form type, the bounding box of the pre-printed portion 1502 is expected to extend throughout the entire sheet. Also, there is a high possibility of the number of detected objects being one or a low number. Also, since the inside is left blank for printing, the ratio of the area with a pixel value of 1 of an object to the area of the bounding box is low. A difference with the form type is that the region of only background portion inside is concentrated in one section and spread widely. This difference can be determined by referencing the pixel values inside the bounding box. Thus, the condition group of type determination for frame type in S702 to S703 according to the third modification example are as follows, for example.

1. (Number of objects) As the result of contour tracking, the number of objects is equal to or less than a predetermined number.

2. (Spread) An object exists with an area of the bounding box having a ratio equal to or greater than a predetermined ratio with respect to the entire sheet. This object is set as a frame candidate object.

3. (Empty inside) The area (with a pixel number of 1) of a frame candidate object is equal to or less than a predetermined ratio with respect to the area of the bounding box. Also, an inscribing box formed of only background portion can be placed inside the bounding box at a certain proportion or greater with respect to the bounding box.

In a case where all of the conditions are satisfied, the pre-printed sheet scan data is deduced to be a frame type. In addition, a condition that an object does not exist in a region outside of the frame, that the pre-printed portion 1502 exists in an end region of the bounding box, and the like may be added.

In S503, the scan data analyzing unit 4303 identifies and stores the information for display. The information stored in the third modification example is the type of the pre-printed sheet scan data and information of the frame structure. The type of pre-printed sheet scan data is the feature of the pre-printed sheet scan data being a frame type. The information of the pattern structure is the coordinates of pixel values of 1 closest to the vertex positions of the bounding box of the object representing the frame. These correspond to the position of the reference point.

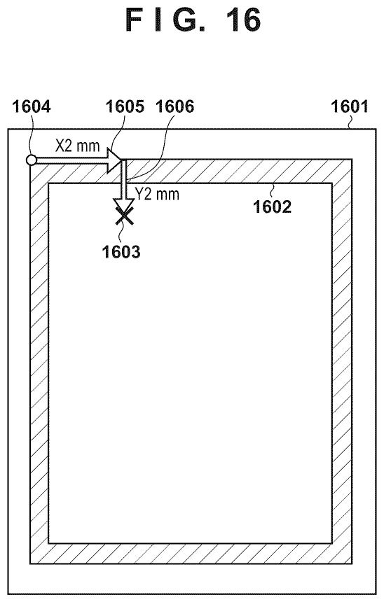

The abnormality information of the inspection result displayed on the inspection UI panel 308 by the inspection result display unit 4309 in S518 according to the third modification example will now be described using FIG. 16. A frame 1601 illustrated in FIG. 16 indicates the entire sheet of the scan data. The frame 1601 corresponds to the frame 1501 representing the entire sheet of the pre-printed sheet of FIG. 15. A pre-printed portion 1602 corresponds to the pre-printed portion 1502 in FIG. 15. Note that as in FIG. 9, the image printed in S509 is not illustrated. In this example, a “spot” abnormality has been detected at a position indicated by an x mark. In such a case, the point closest to the x mark from among the coordinates of the four corners, which is stored frame structure information, is selected as a reference point 1604 (an example of a “vertex outside of the frame”).

The inspection result display unit 4309 instructs as to relative coordinates (X2, Y2) from the reference point 1604 to an abnormality position 1603 using an arrow 1605 in the horizontal direction and an arrow 1606 in the vertical direction. Also, the inspection result display unit 4309 displays the position information (X2 mm and Y2 mm) together at the arrows. Note that though not illustrated in FIG. 16, as with FIG. 11 according to the first modification example, the abnormality position may be displayed with reference to the same X coordinate or Y coordinate as the abnormality position 1603 in the pre-printed portion 1602, which is the frame. Also, in S518 according to the third modification example, the report generating unit 4310 generates an inspection report using an abnormality position display method in a similar manner to the inspection result display unit 4309. According to the third modification example, in this manner, similar effects to that of the embodiments described above are achieved.

### Fourth Modification Example

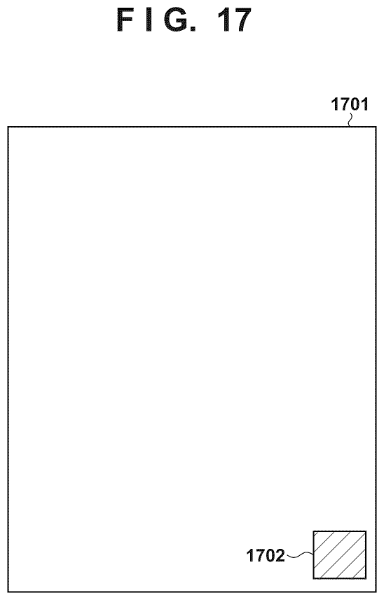

In the fourth modification example, printing such as that illustrated in FIG. 17 is performed in advance on the pre-printed sheet scanned in S501 according to the first modification example. In other words, a pre-printed portion 1702 is pre-printed with an relatively small area in the lower right of a frame 1701 indicating the entire sheet. Such pre-printing may be used in a case where the pre-printed portion 1702 is a company logo, various types of marks, or the like. In the first modification example, by applying the condition that the pre-printed portion 1702 has spread, it is determined that the pre-printed sheet illustrated in FIG. 17 does not include a ruler type feature. However, in this example, a reference point is set in the pre-printed portion 1702 and the abnormality position is displayed in a relative manner.

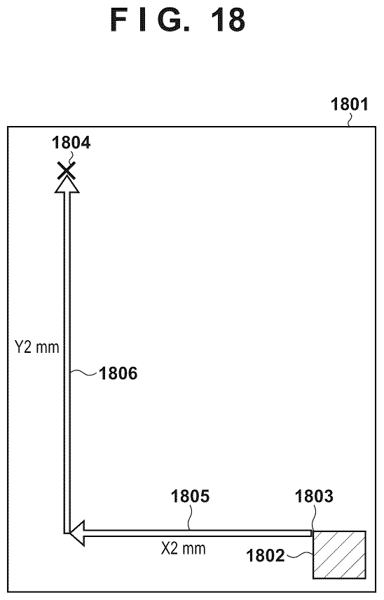

The mode of display of the abnormality position in this case will now be described using FIG. 18. A frame 1801 in FIG. 18 indicates the entire sheet of the scan data and corresponds to the frame 1701 in FIG. 17. A pre-printed portion 1802 corresponds to the pre-printed portion 1702 in FIG. 17. Note that as in FIG. 9, the image printed in S509 is not illustrated. The reference point is set as the upper left vertex of the pre-printed portion 1802. In this example, a “spot” abnormality has been detected at a position indicated by an x mark in FIG. 18.

In such a case, the relative coordinates (X2, Y2) from a reference point 1803 to an abnormality position 1804 has a larger value for the absolute value than the relative coordinates (X1, Y1) using the upper left vertex of the sheet as the origin. Typically, since the pre-printed portion 1802 has a small area, the magnitude of the value that the absolute coordinates and the relative coordinates can take do not significantly change. However, since the pre-printed portion 1802 is printed in the lower right, the position of the reference point with respect to the origin of the absolute coordinates is greatly changed, and the abnormality display is greatly affected by this. Also, even in the case of a relative display referencing a portion of the pre-printed portion 1802, there is little contribution to the ease of comprehending the abnormality position or the entire image. As a result, in this state, even if a relative display is performed from the reference point 1803 of the pre-printed portion 1802, it is expected that there is little merit to displaying to the user, and there is a possibility of confusing the user.

Regarding this, in S503, the scan data analyzing unit 4303 (an example of a “display setting unit”) may set to not perform relative display based on the image when the result of analysis is that the image does not satisfy a predetermined condition. In other words, always performing a relative display based on the image does not always help the user, and it is expected that determining a state of whether to perform relative display is beneficial to the user. In such a case, the scan data analyzing unit 4303 may store the setting to not perform relative display in the RAM 319 or the like as information for display in S503 and may transfer this information to the subsequent flow.

### Other Modification Examples

As illustrated in FIG. 18, in a case where the relative position of the direction from left to right in the horizontal (x) direction and down to up in the vertical (y) direction is displayed, X2 and Y2 may be displayed as negative numbers. However, since the direction is displayed using arrows 1805 and 1806, the absolute value may be displayed as a distance. Alternatively, the display may include negative numbers as absolute values, and in the case of displaying the distance, a display as absolute values and the like may be selectively used.

Also, in the embodiments and modification examples described above, a pre-printing method is used. In the pre-printing method, a large volume of pre-printing sheets with a similar object printed on in advance are produced. Thus, since the user gets used to seeing the object, the relative display using a portion of the object as the position reference makes it easy for the user to see the abnormality. Also, in the pre-printing method, pre-printing and subsequent reprinting are performed at different timing. Thus, the image to be printed can be separated to some extent in terms of structure between the pre-printing and the subsequent reprinting. Thus, deducing the type of the feature is easy. Also, the image being separate and having a structure conducive to matching a type makes user comprehension easier. Also, jobs differ between pre-printing and reprinting, and printing data does not include image information for pre-printing. Thus, to merge both image information, the information of the pre-printing is obtained separately in advance (S501 to S505). Also, to perform feature analysis of the image during execution of these items of processing, delaying of the subsequent abnormality determination processing is reduced. Thus, another advantage of the pre-printing method is in its compatibility with abnormality image inspection.

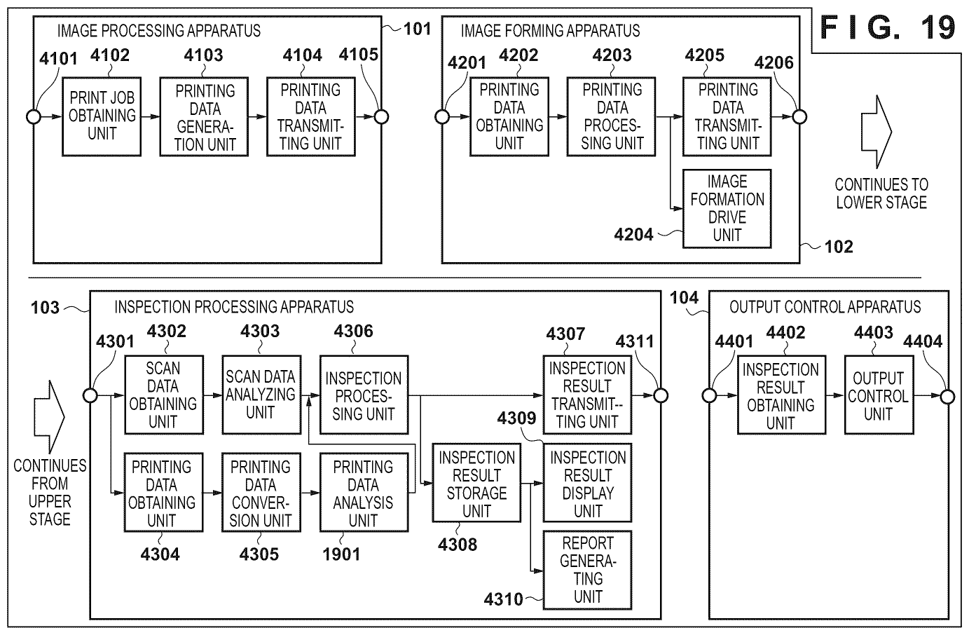

However, in the printed image inspection system 100 according to the present embodiment, printing on the pre-printed sheet as described above may not be performed. In the case of printing which is not the pre-printing method, the analysis processing corresponding toe S501 to S505 in the embodiment is executed on the scan data obtained in S510. Alternatively, the analysis processing may be executed on the printing data processed in S511. This is because, in the case of using the pre-printing method, the printing data includes an object such as a form type. The functional blocks of each apparatus of a printed image inspection system in a case where analysis processing is executed on the printing data will now be described using FIG. 19. The difference between the functional blocks in FIG. 19 and the functional blocks in FIG. 4 is that a printing data analysis unit 1901 is included in the inspection processing apparatus 103. The printing data analysis unit 1901 executes analysis processing on the printing data to analyze the feature of the image. Also, the printing data analysis unit 1901 obtains the object and the inspection target feature. Such a printed image inspection system can be applied to a case in which a pre-printed sheet is not used.

Also, in the embodiments and modification examples described above, a flow in which images are sorted by feature (type) and whether or not various types of features are included is determined. However, these determination may be merged and executed as a single flow. Also, the display method for displaying the abnormality position described above may be partially executed or partially changed. Also, as an alternative to analyzing the image data such as pre-printed sheet scan data and deducing and obtaining its feature, the user may designate information relating to its feature in advance. In such a case, a portion of the determination processing can be omitted as a feature of the image can be obtained without deducing being performed. Alternatively, as the feature reference is known, the thresholds for determination processing and the flow may be changed so that more complex cases in terms of features can be handled.

Also, the method used in deducing and obtaining the feature of the image is not limited to that described above, and an alternative method that achieves a similar result may be used. For example, instead of the Hough transform used in the embodiments, an edge detection filter may be used, and whether or not the image data include a form feature may be determined using a machine learning model. Also, the display method using the relative position in the image may be able to be switched between being performed and not performed at the discretion of the user via a display mode received by the inspection processing apparatus 103.

Also, the configuration inside the printed image inspection system 100 and the segmentation of apparatuses and functional units provided in each apparatus forming the printed image inspection system 100 are not limited to that described above. Apparatuses described as being separate in configuration in the embodiments described above may be an integrated apparatus, or conversely, a single apparatus may be segmented into different apparatus groups. For example, a configuration may be used in which an in-line inspection machine seamlessly performs image processing, image forming, inspection, and discharge. Also, a sheet is used as an example of a printing material in the examples described above, but the printing material may be other sheet material.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-166562, filed Sep. 25, 2024, which is hereby incorporated by reference herein in its entirety.

What is claimed is:

1. An image processing apparatus comprising:
one or more memory devices that store a set of instructions; and
one or more processors that execute the set of instructions to:
obtain an image of one side of a sheet,
process a sheet image obtained and detect a feature of the sheet image,
determine whether or not there is an abnormality in the sheet image obtained based on a feature detected,
set content to be displayed on a screen in a case where it is determined that there is an abnormality in the sheet image, and
output the content set, wherein the one or more processors execute instructions in the one or more memory devices to:
set a reference point in the sheet image and set whether or not to display relative position information indicating a relative position of the abnormality with respect to the reference point, and
set the relative position information to be displayed on the screen in a case where display of the relative position information is set to yes.

2. The image processing apparatus according to claim 1, wherein
the sheet image includes an object which is not a target for determining whether or not there is the abnormality, the one or more processors execute instructions in the one or more memory devices to:
detect the object, and
set the reference point at a position of the object detected.

3. The image processing apparatus according to claim 2, wherein the one or more processors execute instructions in the one or more memory devices to:
in a case where the object satisfies a predetermined type condition, set display of the relative position information to yes and set content to be displayed on the screen in accordance with the predetermined type condition.

4. The image processing apparatus according to claim 3, wherein
the predetermined type includes at least one of a form provided with an entry field inside via a frame line, a ruler provided along a predetermined side of a sheet, a pattern with a plurality of designs arranged, and a frame type with a frame-like shape.

5. The image processing apparatus according to claim 4, wherein
the one or more processors execute instructions in the one or more memory devices to:
in a case where the object is a form type, set a display in which a cell including the abnormality can be identified from among cells included in the form.

6. The image processing apparatus according to claim 5, wherein
the one or more processors execute instructions in the one or more memory devices to:
set a display of content listed in the cell including the abnormality.

7. The image processing apparatus according to claim 4, wherein
the one or more processors execute instructions in the one or more memory devices to:
in a case where the object is a pattern type, set the reference point in a pattern closest to a position where the abnormality is detected.

8. The image processing apparatus according to claim 4, wherein
the one or more processors execute instructions in the one or more memory devices to:
set a display in which the pattern can be identified from other patterns.

9. The image processing apparatus according to claim 4, wherein
the one or more processors execute instructions in the one or more memory devices to:
in a case where the object is a frame type with a rectangular shape, set one of outer vertices of a frame as the reference point.

10. The image processing apparatus according to claim 4, wherein
the one or more processors execute instructions in the one or more memory devices to:
in a case where the object is a ruler type with a rectangular shape, set a point closest to a center of the sheet image from among vertices of a ruler as the reference point.

11. The image processing apparatus according to claim 4, wherein
the one or more processors execute instructions in the one or more memory devices to:
in a case where the object is a ruler type, set an enlarged display of at or near a position of the abnormality and at or near the reference point.

12. The image processing apparatus according to claim 3, wherein
the one or more processors execute instructions in the one or more memory devices to:
in order to identify a relative position of the abnormality with respect to the reference point in the screen, set a display element including a line segment parallel with a left-and-right direction in the sheet image and a line segment parallel with an up-and-down direction.

13. The image processing apparatus according to claim 3, wherein
the one or more processors execute instructions in the one or more memory devices to:
deduce the predetermined type by executing at least one item of processing including binarizing each pixel value of the object, performing tracking of contour of pixels with a first value, and detecting a bounding box circumscribing the contour detected; detecting a straight line in the bounding box; detecting an area of a region enclosed by the bounding box and a total area of the pixels; and detecting centroids of these pixels.

14. The image processing apparatus according to claim 2, wherein
obtaining includes scanning a sheet where the object is formed and the target for determining is not formed, and
the one or more processors execute instructions in the one or more memory devices to:
detect the object from the sheet image scanned.

15. The image processing apparatus according to claim 2, wherein
the one or more processors execute instructions in the one or more memory devices to:
in a case where the object is located at a corner of the sheet image, set display of the relative position information to no.

16. The image processing apparatus according to claim 1, wherein
the one or more processors further execute instructions in the one or more memory devices to:
set absolute position information indicating an absolute position of the abnormality in the sheet image for display on the screen.

17. A control method for an image processing apparatus comprising:
obtaining an image of one side of a sheet;
processing a sheet image obtained and detecting a feature of the sheet image;
determining whether or not there is an abnormality in the sheet image obtained based on a feature detected;
setting content to be displayed on a screen in a case where it is determined that there is an abnormality in the sheet image; and
outputting the content set, wherein
a reference point is set in the sheet image and whether or not to display relative position information indicating a relative position of the abnormality with respect to the reference point is set, and
the relative position information to be displayed on the screen is set in a case where display of the relative position information is set to yes.
